(19) United States
(12) Patent Application Publication
(10) Pub. No.: US 2024/0236706 A1
(43) Pub. Date: Jul. 11, 2024

(54) SIDELINK INITIAL BEAM ACQUISITION

(71) Applicant: Samsung Electronics Co., Ltd., Suwon-si (KR)

(72) Inventor: Emad Nader Farag, Flanders, NJ (US)

(21) Appl. No.: 18/389,594

(22) Filed: Dec. 19, 2023

Related U.S. Application Data
(60) Provisional application No. 63/436,417, filed on Dec. 30, 2022.
(60) Provisional application No. 63/457,678, filed on Apr. 6, 2023.
(60) Provisional application No. 63/465,462, filed on May 10, 2023.

(51) Int. Cl. H04W 16/28; H04B 7/06; H04W 76/10

(52) U.S. Cl. CPC H04W 16/28; H04B 7/0626; H04W 76/10; H04W 92/18

(57) ABSTRACT

Methods and apparatuses for sidelink (SL) initial beam acquisition in a wireless communication system. A method of operating a user equipment (UE) includes transmitting, to a second UE, first channels using multiple spatial domain transmit filters, respectively and receiving, from the second UE, a second channel indicating first assistance information associated with a spatial domain transmit filter. The method further includes determining the spatial domain transmit filter based on the first assistance information and transmitting, based on the spatial domain transmit filter, a third channel that includes a first link establishment message.

### CROSS-REFERENCE TO RELATED APPLICATIONS AND CLAIM OF PRIORITY

The present application claims priority to:
U.S. Provisional Patent Application No. 63/436,417, filed on Dec. 30, 2022;
U.S. Provisional Patent Application No. 63/457,678, filed on Apr. 6, 2023; and
U.S. Provisional Patent Application No. 63/465,462, filed on May 10, 2023. The contents of the above-identified patent documents are incorporated herein by reference.

### TECHNICAL FIELD

The present disclosure relates generally to wireless communication systems and, more specifically, the present disclosure relates to sidelink (SL) initial beam acquisition in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to an SL initial beam acquisition in a wireless communication system.

In one embodiment, a user equipment (UE) is provided. The UE includes a transceiver configured to transmit, to a second UE, first channels using multiple spatial domain transmit filters, respectively, and receive, from the second UE, a second channel indicating first assistance information associated with a spatial domain transmit filter. The UE further includes a processor operably coupled to the transceiver. The processor is configured to determine the spatial domain transmit filter based on the first assistance information. The transceiver is further configured to transmit, based on the spatial domain transmit filter, a third channel that includes a first link establishment message.

In another embodiment, a method of operating a UE is provided. The method includes transmitting, to a second UE, first channels using multiple spatial domain transmit filters, respectively and receiving, from the second UE, a second channel indicating first assistance information associated with a spatial domain transmit filter. The method further includes determining the spatial domain transmit filter based on the first assistance information and transmitting, based on the spatial domain transmit filter, a third channel that includes a first link establishment message.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6A illustrates an example of wireless system beam according to embodiments of the present disclosure;

FIG. 6B illustrates an example of multi-beam operation according to embodiments of the present disclosure;

FIG. 7 illustrates an example of antenna structure according to embodiments of the present disclosure;

FIG. 8 illustrates an example of TCI configuration according to embodiments of the present disclosure;

FIG. 9 illustrates an example of layer-2 link establishment procedure for unicast mode of V2X communication over PC5 reference point according to embodiments of the present disclosure;

FIG. 10 illustrates an example of beam indication according to embodiments of the present disclosure;

FIG. 11 illustrates a flowchart for an example method of communication between a UE-A and a UE-B according to embodiments of the present disclosure;

FIG. 12 illustrates a flowchart for an another example method example of beam indication according to embodiments of the present disclosure;

FIG. 13 illustrates a flowchart for another example method of communication between a UE-A and a UE-B according to embodiments of the present disclosure;

FIG. 14 illustrates yet another example of beam indication according to embodiments of the present disclosure;

FIG. 15 illustrates a flowchart for yet another example method of communication between a UE-A and a UE-B according to embodiments of the present disclosure;

FIG. 16 illustrates an example of time occasion index determination according to embodiments of the present disclosure;

FIG. 17 illustrates another example of time occasion index determination according to embodiments of the present disclosure;

FIG. 18 illustrates yet another example of time occasion index determination according to embodiments of the present disclosure;

FIG. 19 illustrates another example of S-SSBs according to embodiments of the present disclosure;

FIG. 20 illustrates yet another example of beam indication according to embodiments of the present disclosure;

FIGS. 21-23 illustrate yet another examples of time occasion index determinations according to embodiments of the present disclosure; and

FIG. 24 illustrates yet another example of S-SSBs according to embodiments of the present disclosure.

### DETAILED DESCRIPTION

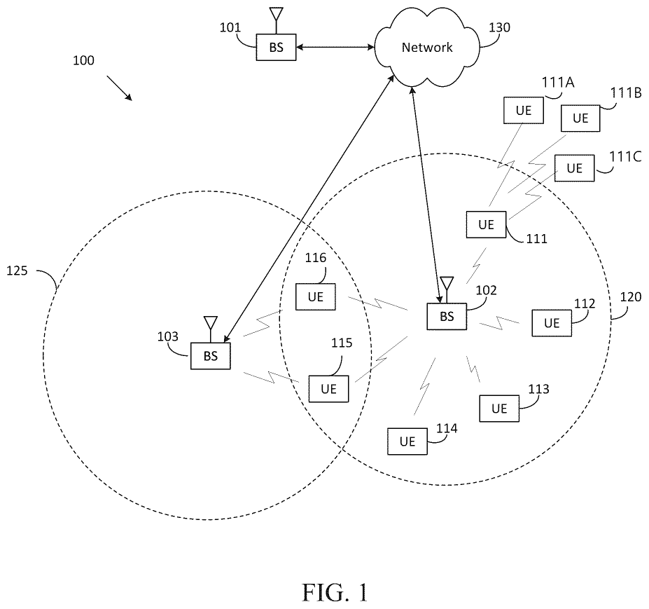

FIG. 1 through FIG. 24, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v17.6.0, “NR; Physical channels and modulation”; 3GPP TS 38.212 v17.6.0, “NR; Multiplexing and Channel coding”; 3GPP TS 38.213 v17.7.0, “NR; Physical Layer Procedures for Control”; 3GPP TS 38.214 v17.7.0, “NR; Physical Layer Procedures for Data”; 3GPP TS 38.321 v17.6.0, “NR; Medium Access Control (MAC) protocol specification”; and 3GPP TS 38.331 v17.6.0, “NR; Radio Resource Control (RRC) Protocol Specification”; and 3GPP TS 36.213 v17.5.0, “Evolved Universal Terrestrial Radio Access (E-UTRA); Physical layer procedures.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

In another example, the UE 116 may be within network coverage and the other UE may be outside network coverage (e.g., UEs 111A-111C). In yet another example, both UEs are outside network coverage. In some embodiments, one or more of the gNBs 101-103 may communicate with each other and with the UEs 111-116 using 5G/NR, LTE, LTE-A, WiMAX, WiFi, or other wireless communication techniques. In some embodiments, the UEs 111-116 may use a device to device (D2D) interface called PC5 (e.g., also known as sidelink at the physical layer) for communication.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for an SL initial beam acquisition in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to traditional fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

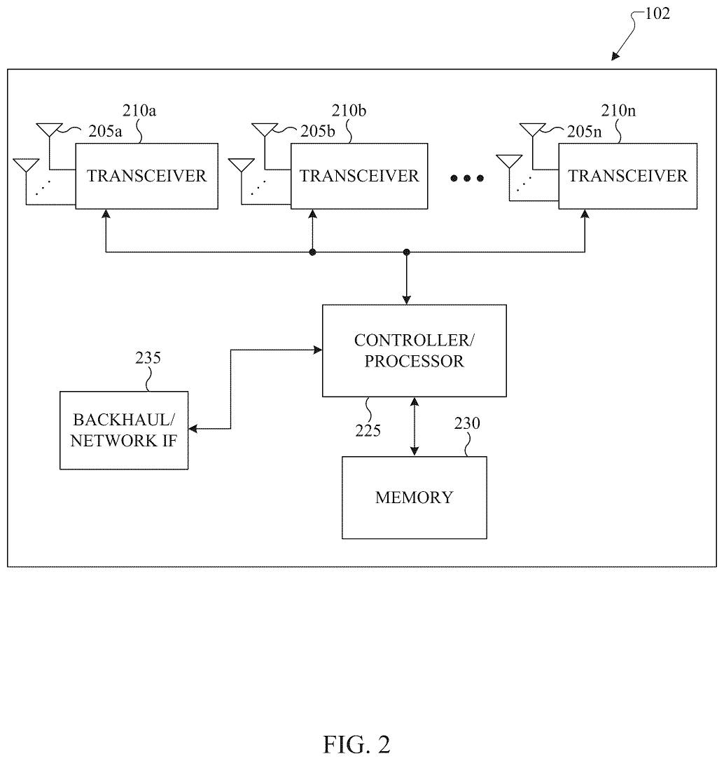

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channels and/or signals and the transmission of DL channels and/or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The controller/processor 225 is also capable of executing programs and other processes resident in the memory 230, such as an OS. The controller/processor 225 can move data into or out of the memory 230 as required by an executing process.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

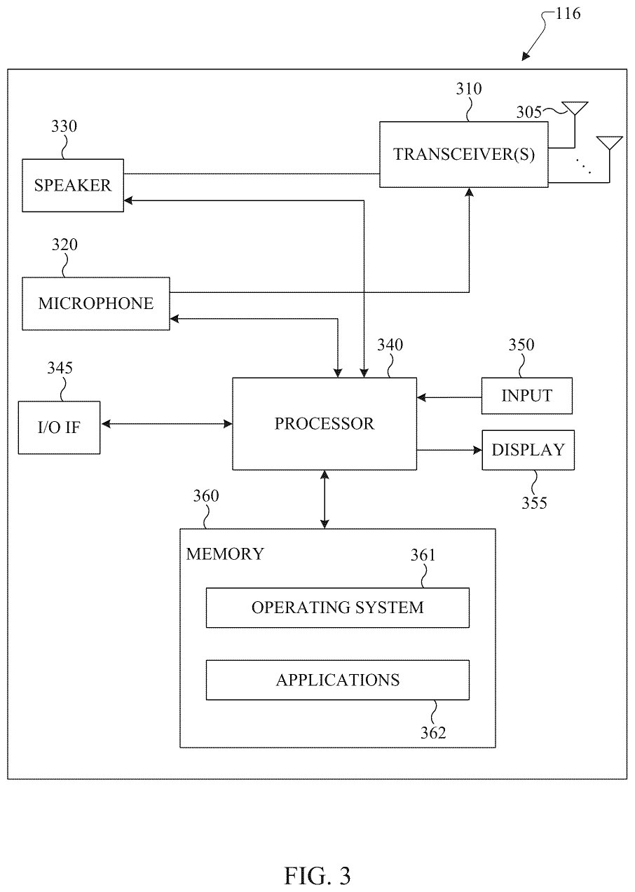

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100 or by other UEs (e.g., one or more of UEs 111-115) on a SL channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels and/or signals or SL channels and/or signals and the transmission of UL channels and/or signals or SL channels and/or signals by the transceiver(s) 310 in accordance with well-known principles. In some embodiments, the processor 340 includes at least one microprocessor or microcontroller.

The processor 340 is also capable of executing other processes and programs resident in the memory 360, such as processes for an SL initial beam acquisition in a wireless communication system.

The processor 340 can move data into or out of the memory 360 as required by an executing process. In some embodiments, the processor 340 is configured to execute the applications 362 based on the OS 361 or in response to signals received from gNBs or another SL UE or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

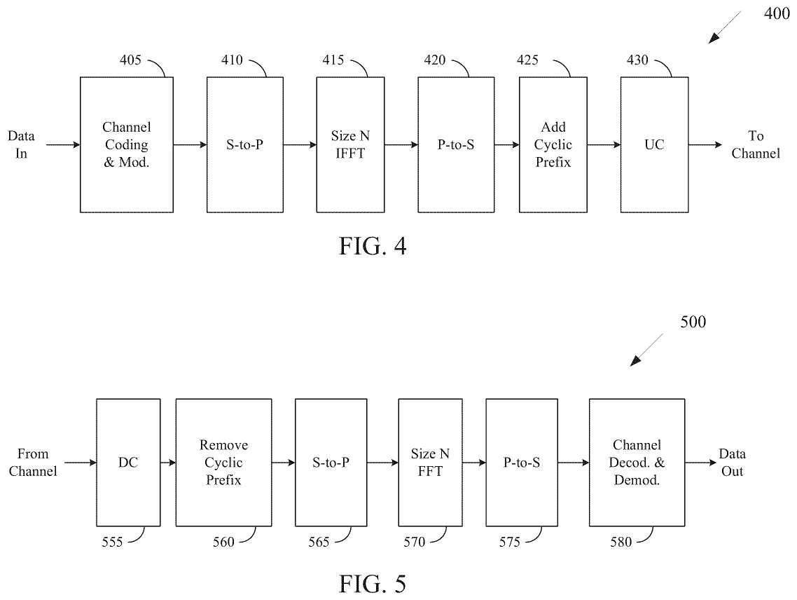

FIG. 4 and FIG. 5 illustrate example wireless transmit and receive paths according to this disclosure. In the following description, a transmit path 400 may be described as being implemented in a first UE (such as the UE 111), while a receive path 500 may be described as being implemented in a second UE (such as a UE 111A). However, it may be understood that the receive path 500 can be implemented in the second UE 111A and that the transmit path 400 can be implemented in the first UE 111. In some embodiments, the transmit path 400 and the receive path 500 are configured to support an SL initial beam acquisition in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102, or UE 115 arrives at the UE 116 after passing through the wireless channel, and reverse operations to those at the gNB 102 or UE 115 are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 or for transmitting in the sidelink to another UE and may implement the receive path 500 for receiving in the downlink from the gNBs 101-103 or for receiving in the sidelink from another UE.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources. A UE can determine CSI-RS transmission parameters through DL control signaling or higher layer signaling, such as an RRC signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

, On the Uu interface a beam can be determined by either of: (1) a TCI state, which establishes a quasi-colocation (QCL) relationship or spatial relationship between a source reference signal (e.g., synchronization signal/physical broadcast channel (PBCH) block (SSB) and/or CSI-RS and/or SRS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels or sidelink channels at the UE, or a spatial Tx filter for transmission of uplink channels or sidelink channels from the UE. The TCI state and/or the spatial relation reference RS can determine a spatial Tx filter for transmission of downlink channels from the gNB, or a spatial Rx filter for transmission of uplink channels at the gNB.

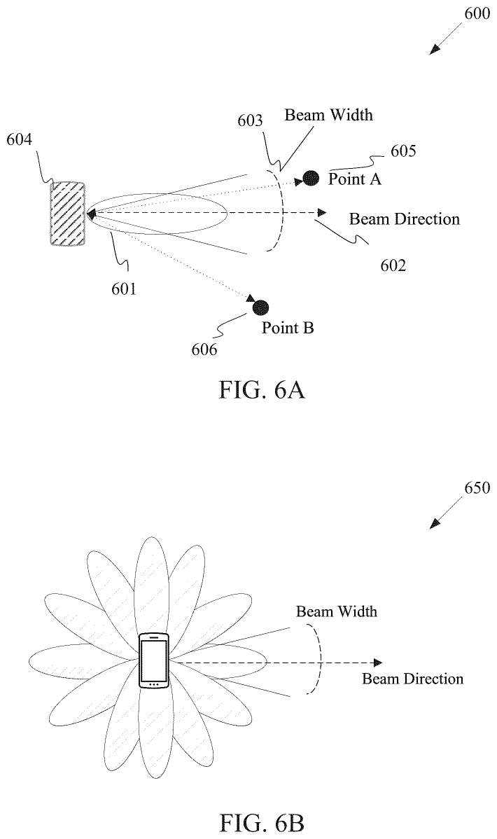

FIG. 6A illustrates an example wireless system beam 600 according to embodiments of the present disclosure. An embodiment of the wireless system beam 600 shown in FIG. 6A is for illustration only.

As illustrated in FIG. 6A, in a wireless system a beam 601, for a device 604, can be characterized by a beam direction 602 and a beam width 603. For example, a device 604 with a transmitter transmits radio frequency (RF) energy in a beam direction and within a beam width. The device 604 with a receiver receives RF energy coming towards the device in a beam direction and within a beam width. As illustrated in FIG. 6A, a device at point A 605 can receive from and transmit to the device 604 as point A is within a beam width of a beam traveling in a beam direction and coming from the device 604.

As illustrated in FIG. 6A, a device at point B 606 cannot receive from and transmit to the device 604 as point B is outside a beam width of a beam traveling in a beam direction and coming from the device 604. While FIG. 6A, for illustrative purposes, shows a beam in 2-dimensions (2D), it may be apparent to those skilled in the art, that a beam can be in 3-dimensions (3D), where the beam direction and beam width are defined in space.

FIG. 6B illustrates an example multi-beam operation 650 according to embodiments of the present disclosure. An embodiment of the multi-beam operation 650 shown in FIG. 6B is for illustration only.

In a wireless system, a device can transmit and/or receive on multiple beams. This is known as “multi-beam operation” and is illustrated in FIG. 6B. While FIG. 6B, for illustrative purposes, is in 2D, it may be apparent to those skilled in the art, that a beam can be 3D, where a beam can be transmitted to or received from any direction in space.

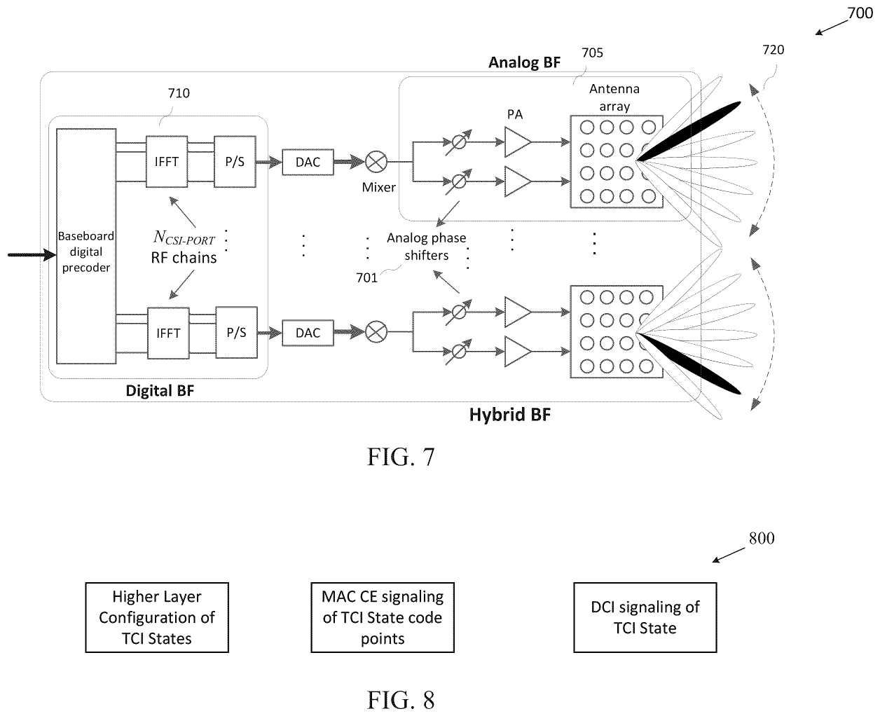

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports —which can correspond to the number of digitally precoded ports—tends to be limited due to hardware constraints (such as the feasibility to install a large number of ADCs/DACs at mmWave frequencies) as illustrated in FIG. 7.

FIG. 7 illustrates an example antenna structure 700 according to embodiments of the present disclosure. For example, the antenna structure 700 may be implemented in user equipment such as UE 111. An embodiment of the antenna structure 700 shown in FIG. 7 is for illustration only.

In this case, one CSI-RS port is mapped onto a large number of antenna elements which can be controlled by a bank of analog phase shifters 701. One CSI-RS port can then correspond to one sub-array which produces a narrow analog beam through analog beamforming 705. This analog beam can be configured to sweep across a wider range of angles 720 by varying the phase shifter bank across symbols or subframes. The number of sub-arrays (equal to the number of RF chains) is the same as the number of CSI-RS ports N_{CSI-PORT}. A digital beamforming unit 710 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL or SL TX beam (also termed “beam indication”), measuring at least one reference signal for calculating and performing beam reporting (also termed “beam measurement” and “beam reporting,” respectively), and receiving a DL or UL or SL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss @100 m distance), larger number of and sharper analog beams (hence larger number of radiators in the array) may be needed to compensate for the additional path loss.

Terminology such as TCI, TCI states, SpatialRelationInfo, target RS, reference RS, and other terms is used for illustrative purposes and is therefore not normative. Other terms that refer to same functions can also be used.

Rel-17 introduced the unified TCI framework, where a unified or master or main or indicated TCI state is signaled to the UE. The unified or master or main or indicated TCI state can be one of: (1) in case of joint TCI state indication, wherein a same beam is used for DL and UL channels, a joint TCI state that can be used at least for UE-dedicated DL channels and UE-dedicated UL channels; (2) in case of separate TCI state indication, wherein different beams are used for DL and UL channels, a DL TCI state that can be used at least for UE-dedicated DL channels; and (3) in case of separate TCI state indication, wherein different beams are used for DL and UL channels, a UL TCI state that can be used at least for UE-dedicated UL channels.

The unified (master or main or indicated) TCI state is a DL or a joint TCI state of UE-dedicated reception on PDSCH/PDCCH and the CSI-RS applying the indicated TCI state and/or an UL or a joint TCI state for dynamic-grant/configured-grant based PUSCH, and SRS applying the indicated TCI state.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell). In Rel-17, UE dedicated channels can be received and/or transmitted using a TCI state associated with a cell having a PCI different from the PCI of the serving cell. While the common channel can be received and/or transmitted using a TCI state associated with the serving cell (e.g., not associated with a cell having a PCI different from the PCI of the serving cell).

Common channels can include: (1) channels carrying system information (e.g., SIB) with a DL assignment carried by a DCI in PDCCH having a CRC scrambled by SI-RNTI and transmitted in Type0-PDCCH CSS set; (2) channels carrying other system information with a DL assignment carried by a DCI in PDCCH having a CRC scrambled by SI-RNTI and transmitted in Type0A-PDCCH CSS set; (3) channels carrying paging or short messages with a DL assignment carried by a DCI in PDCCH having a CRC scrambled by P-RNTI and transmitted in Type2-PDCCH CSS set; and/or (4) channels carrying RACH related channels with a DL assignment or UL grant carried by a DCI in PDCCH having a CRC scrambled by RA-RNTI or TC-RNTI and transmitted in Type1-PDCCH CSS set.

A DL-related DCI format (e.g., DCI Format 1_1 or DCI Format 1_2), with or without DL assignment, can indicate to a UE through a field “transmission configuration indication” a TCI state code point, wherein, the TCI state codepoint can be one of (1) a DL TCI state; (2) an UL TCI state; (3) a joint TCI state; or (4) a pair of DL TCI state and UL TCI state. TCI state code points are activated by MAC CE signaling.

A QCL relation can be quasi-location with respect to one or more of the following relations (e.g., 3GPP standard specification 38.214): (1) Type A, {Doppler shift, Doppler spread, average delay, delay spread}; (2) Type B, {Doppler shift, Doppler spread}; (3) Type C, {Doppler shift, average delay}; and (4) Type D, {Spatial Rx parameter}.

In addition, a quasi-co-location relation and source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g., non-UE dedicated channels, CSI-RS and SRS.

A UE is indicated a TCI state by MAC CE when the CE activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI Format can be with a DL assignment or without a DL assignment. A TCI state (TCI state code point) indicated in a DL related DCI format is applied after a beam application time from the corresponding HARQ-ACK feedback.

The unified (master or main or indicated) TCI state applies at least to UE dedicated DL and UL channels. The unified (master or main or indicated) TCI can also apply to other DL and/or UL channels and/or signals e.g., non-UE dedicated channel, CSI-RS and SRS.

A “reference RS” corresponds to a set of characteristics of a DL beam or an UL TX beam, such as a direction, a precoding/beamforming, a number of ports, and so on.

On a Uu interface, a TCI state can be used for beam indication. It can refer to a DL TCI state for downlink channels (e.g., PDCCH and PDSCH), an uplink TCI state for uplink channels (e.g., PUSCH or PUCCH), a joint TCI state for downlink and uplink channels, or separate TCI states for uplink and downlink channels. A TCI state can be common across multiple component carriers or can be a separate TCI state for a component carrier or a set of component carriers. A TCI state can be gNB or UE panel specific or common across panels. In some examples, the uplink TCI state can be replaced by SRS resource indicator (SRI).

FIG. 8 illustrates an example of TCI configuration 800 according to embodiments of the present disclosure. An embodiment of the TCI configuration 800 shown in FIG. 8 is for illustration only.

A UE can be configured/updated through higher layer RRC signaling (as illustrated in FIG. 8) a set of TCI States with N elements. In one example, DL and joint TCI states are configured by higher layer parameter DLorJoint-TCIState, wherein, the number of DL and Joint TCI state is N_{DJ}. UL TCI state are configured by higher layer parameter UL-TCIState, wherein the number of UL TCI state is N_{U}. N=N_{DJ}+N_{U}. The DLorJoint-TCIState can include DL or Joint TCI states that belong to a serving cell, e.g., the source RS of the TCI state is associated with the serving cell (the PCI of the serving cell), additionally, the DL or Joint TCI states can be associated with a cell having a PCI different from the PCI of the serving cell, e.g., the source RS of the TCI state is associated with a cell having a PCI different from the PCI of the serving cell. The UL-TCIState can include UL TCI states that belong to a serving cell, e.g., the source RS of the TCI state is associated with the serving cell (the PCI of the serving cell), additionally, the UL TCI states can be associated with a cell having a PCI different from the PCI of the serving cell, e.g., the source RS of the TCI state is associated with a cell having a PCI different from the PCI of the serving cell.

MAC CE signaling (as illustrated in FIG. 8) includes activating a subset of M (M≤N) TCI states or TCI state code points from the set of N TCI states, wherein a code point is signaled in the “transmission configuration indication” field of a DCI used for indication of the TCI state. A codepoint can include one TCI state (e.g., DL TCI state or UL TCI state or Joint (DL and UL) TCI state). Alternatively, a codepoint can include two TCI states (e.g., a DL TCI state and an UL TCI state). L1 control signaling (i.e., downlink control information (DCI)) updates the UE's TCI state, wherein the DCI includes a “transmission configuration indication” (beam indication) field e.g., with m bits (such that M≤2^{m}), the TCI state corresponds to a code point signaled by MAC CE. A DCI used for indication of the TCI state can be DL related DCI Format (e.g., DCI Format 1_1 or DCI Format 1_2), with a DL assignment or without a DL assignment.

In the present disclosure, an initial beam acquisition for SL in FR2 during a direct communication request is provided. A first UE, for example UE-B wants to establish a unicast link with a second UE for example UE-A. UE-A sends a beam indication signal to assist UE-B in identifying a preferred beam UE-A uses when communicating with UE-B. UE-B can also transmit a beam indication signal or beam indication signal response to assist UE-A in identifying a preferred beam UE-A uses when communicating with UE-B. This information can be exchanged or signaled between the UE to assist in the transmission and reception of a direct communication request for link establishment

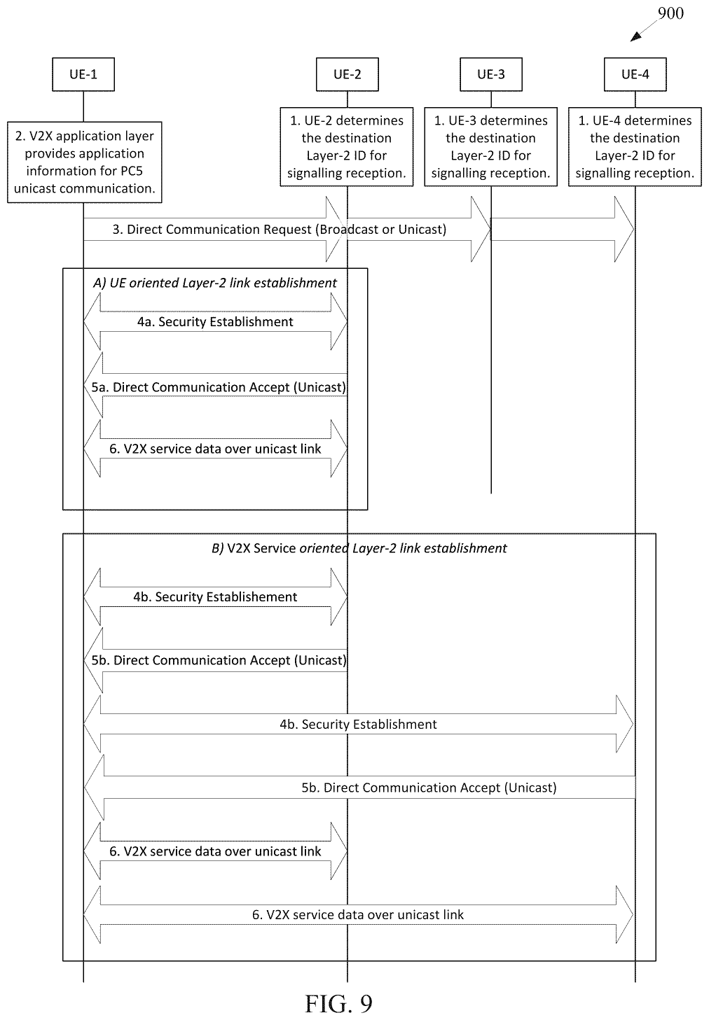

FIG. 9 illustrates an example of layer-2 link establishment procedure 900 for unicast mode of V2X communication over PC5 reference point according to embodiments of the present disclosure. An embodiment of the layer-2 link establishment procedure 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

FIG. 9 illustrates the Layer-2 link establishment procedure for unicast mode of V2X communication over PC5 reference point. As illustrated in FIG. 9, in Step 1, the UE(s) determines the destination Layer-2 ID for signaling reception of PC5 unicast link establishment. This is determined as specified in TS 23.387. The destination Layer-2 ID is configured with the UE(s) as specified in TS 23.387.

In Step 2, the V2X application layer in a UE-1 provides application information for PC5 unicast communicating.

In Step 3, the UE-1 sends a direct communication request (DCR) to initiate the unicast layer-2 link establishment procedure. The UE-1 send the DCR message via PC5 broadcast or unicast using the source Layer-2 ID and destination Layer-2 ID.

In Step 4 (Step 4a or Step 4b), the target UE or the UEs that are interested in using the announced V2X service type(s) over a PC5 unicast link with UE-1 respond establishing the security with UE-1.

In Step 5 (Step 5a or Step 5b), a direct communication accept message is sent to UE-1 by the target UE(s) that has successfully established security with UE-1.

In Step 6, V2X service data is transmitted over the established unicast link.

A time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems (see also REF 1). In addition, a slot can have symbols for SL communications. A UE can be configured one or more bandwidth parts (BWPs) of a system BW for transmissions or receptions of signals or channels. In addition, a slot can have symbols for SL communications. A UE can be configured one or more bandwidth parts (BWPs) of a system BW for transmissions or receptions of signals or channels.

SL signals and channels are transmitted and received on sub-channels within a resource pool, where a resource pool is a set of time-frequency resources used for SL transmission and reception within a SL BWP. SL channels include physical SL shared channels (PSSCHs) conveying data information and second stage/part SL control information (SCI), physical SL control channels (PSCCHs) conveying first stage/part SCI for scheduling transmissions/receptions of PSSCHs, physical SL feedback channels (PSFCHs) conveying hybrid automatic repeat request acknowledgement (HARQ-ACK) information in response to correct (ACK value) or incorrect (NACK value) transport block receptions in respective PSSCHs, PSFCHs can also convey conflict information, and physical SL Broadcast channel (PSBCH) conveying system information to assist in SL synchronization.

SL signals include demodulation reference signals DM-RS that are multiplexed in PSSCH or PSCCH transmissions to assist with data or SCI demodulation, channel state information reference signals (CSI-RS) for channel measurements, phase tracking reference signals (PT-RS) for tracking a carrier phase, and SL primary synchronization signals (S-PSS) and SL secondary synchronization signals (S-SSS) for SL synchronization. SCI can include two parts/stages corresponding to two respective SCI formats where, for example, the first SCI format is multiplexed on a PSCCH and the second SCI format is multiplexed along with SL data on a PSSCH that is transmitted in physical resources indicated by the first SCI format.

A SL channel can operate in different cast modes. In a unicast mode, a PSCCH/PSSCH conveys SL information from one UE to only one other UE. In a groupcast mode, a PSCCH/PSSCH conveys SL information from one UE to a group of UEs within a (pre-)configured set. In a broadcast mode, a PSCCH/PSSCH conveys SL information from one UE to all surrounding UEs. In NR release 16, there are two resource allocation modes for a PSCCH/PSSCH transmission. In resource allocation mode 1, a gNB schedules a UE on the SL and conveys scheduling information to the UE transmitting on the SL through a DCI format (e.g., DCI Format 3_0) transmitted from the gNB on the DL. In resource allocation mode 2, a UE schedules a SL transmission. SL transmissions can operate within network coverage where each UE is within the communication range of a gNB, outside network coverage where all UEs have no communication with any gNB, or with partial network coverage, where only some UEs are within the communication range of a gNB.

In case of groupcast PSCCH/PSSCH transmission, a UE can be (pre-)configured one of two options for reporting of HARQ-ACK information by the UE: (1) HARQ-ACK reporting option (1): A UE can attempt to decode a transport block (TB) in a PSSCH reception if, for example, the UE detects a SCI format scheduling the TB reception through a corresponding PSSCH. If the UE fails to correctly decode the TB, the UE multiplexes a negative acknowledgement (NACK) in a PSFCH transmission. In this option, the UE does not transmit a PSFCH with a positive acknowledgment (ACK) when the UE correctly decodes the TB and/or (2) HARQ-ACK reporting option (2): A UE can attempt to decode a TB if, for example, the UE detects a SCI format that schedules a corresponding PSSCH. If the UE correctly decodes the TB, the UE multiplexes an ACK in a PSFCH transmission; otherwise, if the UE does not correctly decode the TB, the UE multiplexes a NACK in a PSFCH transmission.

In HARQ-ACK reporting option (1), when a UE that transmitted the PSSCH detects a NACK in a PSFCH reception, the UE can transmit another PSSCH with the TB (retransmission of the TB). In HARQ-ACK reporting option (2) when a UE that transmitted the PSSCH does not detect an ACK in a PSFCH reception, such as when the UE detects a NACK or does not detect a PSFCH reception, the UE can transmit another PSSCH with the TB.

A sidelink resource pool includes a set/pool of slots and a set/pool of RBs used for sidelink transmission and sidelink reception. A set of slots which belong to a sidelink resource pool can be denoted by {t′₀ ^{SL}, t′₁ ^{SL}, t′₂ ^{SL}, . . . , t′_{T′}_{_{MAX}}₋₁^{SL}} and can be configured, for example, at least using a bitmap. Where, T′_{MAX} is the number of SL slots in a resource pool within 1024 frames. Within each slot t′_{y}^{SL} of a sidelink resource pool, there are N_{subCH} contiguous sub-channels in the frequency domain for sidelink transmission, where N_{subCH} is provided by a higher-layer parameter. Subchannel m, where m is between 0 and N_{subCH}−1, is given by a set of n_{subCHsize} contiguous PRBs, given by n_{PRB}=n_{subCHstart}+m·n_{subCHsize}+j, where j=0, 1, . . . , n_{subCHsize}−1, n_{subCHstart} and n_{subCHsize} are provided by higher layer parameters.

For resource (re-)selection or re-evaluation in slot n, a UE can determine a set of available single-slot resources for transmission within a resource selection window [n+T₁, n+T₂], such that a single-slot resource for transmission, R_{x,y} is defined as a set of L_{subCH} contiguous subchannels x+i, where i=0, 1, . . . , L_{subCH}−1 in slot t_{y}^{SL}. T₁ is determined by the UE such that, 0≤T₁≤T_{proc,1}^{SL}, where T_{proc,1}^{SL} is a PSSCH processing time for example as defined in TS 38.214. T₂ is determined by the UE such that T₂ₘᵢₙ≤T₂≤Remaining Packet Delay Budget, as long as T₂ₘᵢₙ<Remaining Packet Delay Budget, else T₂ is equal to the Remaining Packet Delay Budget. T₂ₘᵢₙ is a configured by higher layers and depends on the priority of the SL transmission.

The slots of a SL resource pool are determined as following examples.

In one example, let set of slots that may belong to a resource be denoted by {t₀ ^{SL}, t₁ ^{SL}, t₂ ^{SL}, . . . , t_{T}_{_{MAX}}₋₁^{SL}}, where 0≤tᵢ^{SL}<10240×2^{μ}, and 0≤i<Tₘₐₓ·μ is the sub-carrier spacing configuration. μ=0 for a 15 kHz sub-carrier spacing. μ=1 for a 30 kHz sub-carrier spacing. μ=2 for a 60 kHz sub-carrier spacing. μ=3 for a 120 kHz sub-carrier spacing. The slot index is relative to slot #0 of system frame number (SFN) #0 of the serving cell, or direct frame number (DFN) #0. The set of slots includes all slots except: (1) N_{S-SSB} slots that are configured for SL SS/PBCH Block (S-SSB); (2) N_{nonSL} slots where at least one SL symbol is not semi-statically configured as UL symbol by higher layer parameter tdd-UL-DL-ConfigurationCommon or sl-TDD-Configuration. In a SL slot, OFDM symbols Y-th, (Y+1)-th, . . . , (Y+X−1)-th are SL symbols, where Y is determined by the higher layer parameter sl-StartSymbol and X is determined by higher layer parameter sl-LengthSymbols; and (3) N_{reserved} reserved slots. Reserved slots are determined such that the slots in the set {t₀ ^{SL}, t₁ ^{SL}, t₂ ^{SL}, . . . , t_{T}_{_{MAX}}₋₁^{SL}} is a multiple of the bitmap length (L_{bitmap}), where the bitmap (b₀, b₁, . . . , b_{L}_{_{bitmap}}₋₁) is configured by higher layers. The reserved slots are determined as follows: (i) let {l₀, l₁, . . . , l₂_{^{μ}}_{×10240-N}_{_{S-SSB}}_{-N}_{_{nonSL}} ₋₁} be the set of slots in range 0 . . . 2^{μ}×10240−1, excluding S-SSB slots and non-SL slots. The slots are arranged in ascending order of the slot index; (ii) the number of reserved slots is given by: N_{reserved}=(2^{μ}×10240−N_{S-SSB}−N_{nonSL}) mod L_{bitmap}; and (iii) the reserved slots lᵣ are given by:

$$r = ⌊ \frac{m \cdot ( {2}^{μ} \times 10240 - {N}_{S - SSB} - {N}_{nonSL} )}{{N}_{reserved}} ⌋ , \\ where , m = 0 , 1 , … , {N}_{reserved} - 1$$

and Tₘₐₓ is given by: Tₘₐₓ=2^{μ}×10240−N_{S-SSB}−N_{nonSL}−N_{reserved}.

In one example, the slots are arranged in ascending order of slot index.

In one example, the set of slots belonging to the SL resource pool, {t′₀ ^{SL}, t′₁ ^{SL}, t′₂ ^{SL}, . . . , t′_{T′}_{_{MAX}}₋₁^{SL}}, are determined as follows: (1) each resource pool has a corresponding bitmap (b₀, b₁, . . . , b_{L}_{_{bitmap}}_{-1) of length L}_{bitmap}; (2) a slot tₖ^{SL} belongs to the SL resource pool if b_{k mod L}_{_{bitmap}}₌1; and (3) the remaining slots are indexed successively staring from 0, 1, . . . T′_{MAX}−1. Where, T′_{MAX} is the number of remaining slots in the set.

Slots can be numbered (indexed) as physical slots or logical slots, wherein physical slots include all slots numbered sequential, while logical slots include only slots that are allocated to sidelink resource pool as described above numbered sequentially. The conversion from a physical duration, Pᵣₛᵥₚ, in milli-second to logical slots, P′ᵣₛᵥₚ, is given by

$${P}_{rsvp}^{′} = ⌈ \frac{T {′}_{max}}{10240 ms} \times {P}_{rsvp} ⌉$$

(see 3GPP standard specification 38.214).

For resource (re-)selection or re-evaluation in slot n, a UE can determine a set of available single-slot resources for transmission within a resource selection window [n+T₁, n+T₂], such that a single-slot resource for transmission, R_{x,y} is defined as a set of L_{subCH} contiguous subchannels x+i, where i=0, 1, . . . , L_{subCH}−1 in slot t_{y}^{SL}. T₁ is determined by the UE such that, 0≤T₁≤T_{proc,1}^{SL} where T_{proc,1}^{SL} is a PSSCH processing time for example as defined in 3GPP standard specification, TS 38.214. T₂ is determined by the UE such that T₂ₘᵢₙ≤T₂≤rRemaining Packet Delay Budget, as long as T₂ₘᵢₙ<Remaining Packet Delay Budget, else T₂ is equal to the Remaining Packet Delay Budget. T₂ₘᵢₙ is configured by higher layers and depends on the priority of the SL transmission.

The resource (re-)selection is a two-step procedure: (1) the first step (e.g., performed in the physical layer) is to identify the candidate resources within a resource selection window. Candidate resources are resources that belong to a resource pool, but exclude resources (e.g., resource exclusion) that were previously reserved, or potentially reserved by other UEs. The resources excluded are based on SCIs decoded in a sensing window and for which the UE measures a SL RSRP that exceeds a threshold. The threshold depends on the priority indicated in a SCI format and on the priority of the SL transmission. Therefore, sensing within a sensing window involves decoding the first stage SCI, and measuring the corresponding SL RSRP, wherein the SL RSRP can be based on PSCCH DMRS or PSSCH DMRS. Sensing is performed over slots where the UE does not transmit SL. The resources excluded are based on reserved transmissions or semi-persistent transmissions that can collide with the excluded resources or any of reserved or semi-persistent transmissions. The identified candidate resources after resource exclusion are provided to higher layers; and (2) the second step (e.g., performed in the higher layers) is to select or re-select a resource from the identified candidate resources for PSSCH/PSCCH transmission.

During the first step of the resource (re-)selection procedure, a UE can monitor slots in a sensing window [n−T₀,n−T_{proc,0}^{SL}), where the UE monitors slots belonging to a corresponding sidelink resource pool that are not used for the UE's own transmission. For example, T_{proc,0}^{SL} is the sensing processing latency time, for example as defined in 3GPP standard specification, TS 38.214.

To determine a candidate single-slot resource set to report to higher layers, a UE excludes (e.g., resource exclusion) from the set of available single-slot resources for SL transmission within a resource pool and within a resource selection window, the following examples.

In one example, single slot resource R_{x,y}, such that for any slot t′ₘ^{SL} not monitored within the sensing window with a hypothetical received SCI Format 1-0, with a “resource reservation period” set to any periodicity value allowed by a higher layer parameter reservationPeriodAllowed, and indicating all sub-channels of the resource pool in this slot, satisfies condition 2.2. below.

In one example, single slot resource R_{x,y}, such that for any received SCI within the sensing window: (1) the associated L1-RSRP measurement is above a (pre-)configured SL-RSRP threshold, where the SL-RSRP threshold depends on the priority indicated in the received SCI and that of the SL transmission for which resources are being selected; and (2) (Condition 2.2) The received SCI in slot t′ₘ^{SL}, or if “Resource reservation field” is present in the received SCI the same SCI is assumed to be received in slot t′_{m+q×P′}_{_{rsvp_Rx}}^{SL}, indicates a set of resource blocks that overlaps R_{x,y+j×P′}_{_{rsvp_Tx′}}

Where, q=1,2, . . . , Q, where, if

$${P}_{rsvp \_ RX} \leq {T}_{scal} and {n}^{′} - m < {P}_{rsvp \_ Rx}^{′} \to Q = ⌈ \frac{{T}_{scal}}{{P}_{rsvp \_ RX}} ⌉ .$$

T_{scal} is T₂ in units of milli-seconds, else Q=1. If n belongs to (t′₀ ^{SL}, t′₁ ^{SL}, . . . , t′_{T′}_{_{max−1}}^{SL}), n′=n, else n′ is the first slot after slot n belonging to set (t′₀^{SL}, t′₁^{SL}, . . . , t′_{T′}_{ₘₐₓ}₋₁^{SL}). j=0, 1, . . . , Cᵣₑₛₑₗ−1. P_{rsvp_RX} is the indicated resource reservation period in the received SCI in physical slots, and P′_{rsvp_Rx} is that value converted to logical slots. P′_{rsvp_Tx} is the resource reservation period of the SL transmissions for which resources are being reserved in logical slots.

In one example, if the candidate resources are less than a (pre-)configured percentage given by higher layer parameter sl_TxPrecentageList(prio_{TX}) that depends on the priority of the SL transmission prior_{TX}, such as 20%, of the total available resources within the resource selection window, the (pre-)configured SL-RSRP thresholds are increased by a predetermined amount, such as 3 dB.

A NR sidelink introduced two new procedures for mode 2 resource allocation; re-evaluation and pre-emption.

Re-evaluation check occurs when a UE checks the availability of pre-selected SL resources before the resources are first signaled in an SCI Format, and if needed re-selects new SL resources. For a pre-selected resource to be first-time signaled in slot m, the UE performs a re-evaluation check at least in slot m−T₃.

The re-evaluation check includes: (1) performing the first step of the SL resource selection procedure as defined in the 3GPP specifications (e.g., TS38.214), which involves identifying a candidate (available) sidelink resource set in a resource selection window as previously described.

If the pre-selected resource is available in the candidate sidelink resource set, the resource is used/signaled for sidelink transmission. Else, the pre-selected resource is not available in the candidate sidelink resource set, a new sidelink resource is re-selected from the candidate sidelink resource set.

A pre-emption check occurs when a UE checks the availability of pre-selected SL resources that have been previously signaled and reserved in an SCI Format, and if needed re-selects new SL resources. For a pre-selected and reserved resource to be signaled in slot m, the UE performs a pre-emption check at least in slot m−T₃.

When pre-emption check is enabled by higher layers, pre-emption check includes: (1) performing the first step of the SL resource selection procedure as defined in the 3GPP specifications (e.g., 38.214), which involves identifying candidate (available) sidelink resource set in a resource selection window as previously described; (2) if the pre-selected and reserved resource is available in the candidate sidelink resource set, the resource is used/signaled for sidelink transmission; and (3) else, the pre-selected and reserved resource is NOT available in the candidate sidelink resource set. The resource is excluded from the candidate resource set due to an SCI, associated with a priority value P_{RX}, having an RSRP exceeding a threshold. Let the priority value of the sidelink resource being checked for pre-emption be P_{TX}.

If the priority value P_{RX} is less than a higher-layer configured threshold and the priority value P_{RX} is less than the priority value P_{TX}. The pre-selected and reserved sidelink resource is pre-empted. A new sidelink resource is re-selected from the candidate sidelink resource set. Note that, a lower priority value indicates traffic of higher priority. Else, the resource is used/signaled for sidelink transmission.

As described above, the monitoring procedure for resource (re)selection during the sensing window requires sensing which includes reception and decoding of a SCI format during the sensing window as well as measuring the SL RSRP. This reception and decoding process and measuring the SL RSRP increases a processing complexity and power consumption of a UE for sidelink communication and requires the UE to have receive circuitry on the SL for sensing even if the UE only transmits and does not receive on the sidelink. The aforementioned sensing procedure is referred to a full sensing.

3GPP Release 16 is the first NR release to include sidelink through work item “5G V2X with NR sidelink,” the mechanisms introduced focused mainly on vehicle-to-everything (V2X) and can be used for public safety when the service requirement can be met. Release 17 extends sidelink support to more use cases through work item “NR Sidelink enhancement.” The objectives of Rel-17 SL include: (1) Resource allocation enhancements that reduce power consumption. (2) enhanced reliability and reduced latency.

Rel-17 introduced low-power resource allocation. Low-power resource allocation schemes include partial sensing and random resource selection. If a SL transmission from a UE is periodic, partial sensing can be based on periodic-based partial sensing (PBPS), and/or contiguous partial sensing (CPS). If a SL transmission from a UE is aperiodic, partial sensing can be based on CPS and PBPS if the resource pool supports periodic reservations (i.e., sl_multiReserveResource is enabled). When a UE performs PBPS, the UE selects a set of Y slots (Y≥Yₘᵢₙ) within a resource selection window corresponding to PBPS, where Yₘᵢₙ is provided by higher layer parameter minNumCandidateSlotsPeriodic. The UE monitors slots at t′_{y-k×P}_{ᵣₑₛₑᵣᵥₑ}^{SL}, where t′_{y}^{SL} is a slot of the Y selected candidate slots.

The periodicity value for sensing for PBPS, i.e., Pᵣₑₛₑᵣᵥₑ is a subset of the resource reservation periods allowed in a resource pool provided by higher layer parameter sl-ResourceReservePeriodList. Pᵣₑₛₑᵣᵥₑ is provided by higher layer parameter periodicSensingOccasionReservePeriodList, if not configured, Pᵣₑₛₑᵣᵥₑ includes all periodicities in sl-ResourceReservePeriodList. The UE monitors k sensing occasions determined by additionalPeriodicSensingOccasion, as previously described, and not earlier than n−T₀. For a given periodicity Pᵣₑₛₑᵣᵥₑ, the values of k correspond to the most recent sensing occasion earlier than t′_{y0}^{SL}−(T_{proc,0}^{SL}+T_{proc,1}^{SL}) if additionalPeriodicSensingOccasion is not (pre-)configured, and additionally includes the value of k corresponding to the last periodic sensing occasion prior to the most recent one if additionalPeriodicSensingOccasion is (pre-)configured. t′_{y0}^{SL} is the first slot of the selected Y candidate slots of PBPS. When a UE performs CPS, the UE selects a set of Y′ slots (Y′≥Y′ₘᵢₙ) within a resource selection window corresponding to CPS, where Y′ₘᵢₙ is provided by higher layer parameter minNumCandidateSlotsAperiodic. The sensing window for CPS starts at least M logical slots before t′_{y0}^{SL} (the first of the Y′ candidate slots) and ends at t′_{y0}^{SL}−(T_{proc,0}^{SL}+T_{proc,1}^{SL}).

Rel-17 introduced inter-UE co-ordination (IUC) to enhance the reliability and reduce the latency for resource allocation, where SL UEs exchange information with one another over sidelink to aid the resource allocation mode 2 (re-)selection procedure. A UE-A provides information to UE-B, and UE-B uses the provided information for the resource allocation mode 2 (re-)selection procedure. IUC is designed to address issues with distributed resource allocation such as: (1) hidden node problem, where a UE-B is transmitting to a UE-A and UE-B cannot sense or detect transmissions from a UE-C that interfere with the transmission to a UE-A, (2) exposed node problem, where a UE-B is transmitting to a UE-A, and UE-B senses or detects transmissions from a UE-C and avoids the resources used or reserved by UE-C, but UE-C does not cause interference at UE-A, (3) Persistent collision problem, and (4) Half-duplex problem, where UE-B is transmitting to a UE-A in the same slot that the UE-A is transmitting in, the UE-A may miss the transmission from UE-B as UE-A cannot receive and transmit in the same slot.

There are two schemes for inter-UE co-ordination as shown in following examples.

In one example, in scheme 1, a UE-A can provide to another UE-B indications of resources that are preferred to be included in UE-B's (re-)selected resources, or non-preferred resources to be excluded for UE-B's (re-)selected resources. When given preferred resources, UE-B may use only those resources for the UE-B's resource (re-)selection, or UE-B may combine them with resources identified by its own sensing procedure, e.g., by finding the intersection of the two sets of resources, for its resource (re-)selection. When given non-preferred resources, UE-B may exclude these resources from resources identified by its own sensing procedure for its resource (re-)selection.

Transmissions of co-ordination information (e.g., IUC messages) sent by a UE-A to a UE-B, and co-ordination information requests (e.g., IUC requests) sent by the UE-A to the UE-B, are sent in a MAC-CE message and may also, if supported by the UEs, be sent in a 2^{nd}-stage SCI Format (SCI Format 2-C). The benefit of using the 2nd stage SCI is to reduce latency. IUC messages from the UE-A to the UE-B can be sent standalone, or can be combined with other SL data. Coordination information (IUC messages) can be in response to a request from the UE-B, or due to a condition at the UE-A. An IUC request is unicast from the UE-B to the UE-A, in response to the UE-A sends an IUC message in unicast mode to the UE-B. An IUC message transmitted as a result of an internal condition at the UE-A can be unicast to the UE-B, when the IUC message includes preferred resources, or can be unicast, groupcast or broadcast to the UE-B when the IUC message includes non-preferred resources. The UE-A can determine preferred or non-preferred resources for the UE-B based on its own sensing taking into account the SL-RSRP measurement of the sensed data and the priority of the sensed data, i.e., the priority field of the decoded PSCCH during sensing as well as the priority the traffic transmitted by the UE-B in case of request-based IUC or a configured priority in case of condition-based IUC. Non-preferred resource to the UE-B can also be determined to avoid the half-duplex problem, where the UE-A cannot receive data from a UE-B in the same slot the UE-A is transmitting.

In another example, in scheme 2, a UE-A can provide to another UE-B an indication that resources reserved for UE-B's transmission, whether or not the UE-A is the destination UE of these resources, are subject to conflict with a transmission from another UE. The UE-A determines the conflicting resources based on the priority and RSRP of the transmissions involved in the conflict. UE-A can also determine a presence of a conflict due to the half-duplex problem, where the UE-A cannot receive a reserved resource from the UE-B at the same time the UE-A is transmitting. When the UE-B receives a conflict indication for a reserved resource, the UE-B can re-select new resources to replace them.

The conflict information from the UE-A is sent in a PSFCH channel separately (pre-)configured from the PSFCH of the SL-HARQ operation. The timing of the PSFCH channel carrying conflict information can be based on the SCI indicating reserved resource or based on the reserved resource.

In both schemes, the UE-A can identify resources according to a number of conditions which are based on the SL-RSRP of the resources in question as a function of the traffic priority, and/or whether the UE-A may be unable to receive a transmission from the UE-B, due to performing its own transmission, i.e., a half-duplex problem. The purpose of this exchange of information is to give the UE-B information about resource occupancy acquired by the UE-A which the UE-B may not be able to determine on its own due to hidden nodes, exposed nodes, persistent collisions, etc.

Release 18 considers further evolution of the NR SL air interface for operation in unlicensed bands, beam-based operation in FR2, SL carrier aggregation and co-channel co-existence between LTE SL and NR SL.

The present disclosure considers initial beam acquisition for SL in FR2 during a direct communication request. A first UE, for example, the UE-B wants to establish a unicast link with a second UE for example UE-A or vice versa. In one example, the UE-A sends a beam indication signal to assist the UE-B in identifying a preferred beam the UE-A uses when communicating with the UE-B. In another example, the UE-B can also transmit a beam indication signal or beam indication signal response to assist the UE-A in identifying a preferred beam the UE-B uses when communicating with the UE-A, or UE-A uses when communicating with UE-B. This information can be exchanged or signaled between the UEs to assist in the transmission and/or reception of a direct communication request for link establishment.

3GPP Release 16 is the first NR release to include sidelink through work item “5G V2X with NR sidelink,” the mechanisms introduced focused mainly on vehicle-to-everything (V2X), and can be used for public safety when the service requirement can be met. Release 17 extends sidelink support to more use cases through work item “NR Sidelink enhancement” (RP-201385). Release 18 considers further evolution of the NR SL air interface for operation in unlicensed bands, beam-based operation in FR2, SL carrier aggregation and co-channel co-existence between LTE SL and NR SL. One of the key features of NR is its ability to support beam-based operation. This is especially important for operation in FR2 which suffers a higher propagation loss. In Rel-16 and Rel-17 the main focus of developing SL was FR1. Indeed, the frequency bands supported for SL in Rel-16 and Rel-17 are all sub-6 GHz frequencies (bands n14, n38, n47, and n79).

One of the objectives of Rel-18 is to expand SL to FR2, while SL supports SL phase tracking reference signal (PTRS), an important feature to support operation in FR2, i.e., beam management, is missing. In this disclosure, aspects related to initial beam acquisition is provided such as: (1) Transmission and reception of beam indication signal to help identify beams. (2) Transmission and reception of direct communication request based on beams identified, e.g., by the beam indication signal at the UE-B.

The present disclosure considers aspects related to initial beam acquisition for SL communication in FR2: (1) Transmission and reception of beam indication signal to help identify beams. (2) Transmission and reception of direct communication request based on beams identified prior to link establishment, e.g., by the beam indication signal.

In SL, “reference RS” can correspond to a set of characteristics for SL beam, such as a direction, a precoding/beamforming, a number of ports, and so on. This can correspond to a SL receive beam or to a SL transmit beam. At least two UE's are involved in a SL communication. It is referred to a first UE as the UE-A and to second UE as the UE-B. In one example, the UE-A is transmitting SL data on PSSCH/PSCCH, and the UE-B is receiving the SL data on PSSCH/PSCCH, the roles of UE-A and UE-B can be reversed.

For mmWave bands (or FR2) or for higher frequency bands (such as >52.6 GHz) where multi-beam operation is especially relevant, a transmission-reception process includes a receiver in a second UE (e.g., UE-B) selecting a receive (RX) beam for a given TX beam from a first UE (e.g., UE-A). During the initiation of a communication session between the UE-A and the UE-B a beam pair is determined for communication from the UE-A to the UE-B, i.e., a transmit beam from the UE-A is paired with a receive beam from the UE-B. A beam pair is also determined for communication from the UE-B to the UE-A, i.e., a transmit beam from the UE-B is paired with a receive beam from the UE-A.

In the present disclosure a beam is also referred to as a spatial domain filter. For example, a transmit beam is a spatial domain transmission (or transmit) filter, and a receive beam is a spatial domain reception (or receive) filter.

In the present disclosure, RRC signaling (e.g., configuration by RRC signaling) includes the following: (1) RRC signaling over the Uu interface, this can be system information block (SIB)-based RRC signaling (e.g., SIB1 or other SIB) or RRC dedicated signaling that is sent to a specific UE, and/or (2) PC5-RRC signaling over the PC5 or SL interface.

In the present disclosure, MAC CE signaling includes: (1) MAC CE signaling over the Uu interface, and/or (2) MAC CE signaling over the PC5 or SL interface.

In the present disclosure, L1 control signaling includes: (1) L1 control signaling over the Uu interface, this can include (1a) DL control information (e.g., DCI on PDCCH) and/or (1b) UL control information (e.g., UCI on PUCCH or PUSCH), and/or (2) SL control information over the PC5 or SL interface, this can include (2a) first stage sidelink control information (e.g., first stage SCI on PSCCH), and/or (2b) second stage sidelink control information (e.g., second stage SCI on PSSCH) and/or (2c) feedback control information (e.g., control information carried on PSFCH).

In the present disclosure, a beam report or beam measurement report can be (1) a periodic report, e.g., preconfigured or configured by higher layers, (2) a semi-persistent report that is activated and/or deactivated by MAC CE signaling and/or L1 control signaling, or (3) aperiodic report that is triggered by L1 control signaling and/or MAC CE signaling.

In the present disclosure, the container of a report (e.g., beam report (or beam measurement report) or a beam indication message) can be: (1) MAC CE report, for example MAC CE report can reuse the MAC CE CSI report on the SL PC5 interface, (2) SCI report container, the SCI report container can be first stage SCI (e.g., conveyed by PSCCH) and/or a second stage SCI (e.g., conveyed by PSSCH). In one example, the second stage SCI is a standalone second stage SCI in PSSCH, with no sidelink shared channel (SL-SCH) in PSSCH. In another example, the second stage SCI is multiplexed in PSSCH with a MAC CE carrying the report with no other SL data. In another example, the second stage SCI is multiplexed in PSSCH with a MAC CE carrying the report and other SL data. In another example, the second stage SCI is multiplexed in PSSCH with other SL data e.g., in a SL-SCH, (3) a PSFCH report container. In one example, the PSFCH can be redesigned to carry more than one bit of information, e.g., a PSFCH with N bits of information and N>1. In one example, a report is one bit, for example, indicating if a beam is good (e.g., valid) or bad (e.g., invalid). In one example, a report is N bits, with N being a small number and N PSFCHs are used; and/or (4) if a UE is in network coverage, the report can be sent to the network using UCI on PUCCH or PUSCH and/or the report can be sent to the network using MAC CE on the Uu interface.

In the present disclosure, a beam can be identified for communication between a first UE and a second UE. In one example for the first UE, a same beam is used to transmit PSSCH/PSCCH and PSFCH from the first UE to the second UE. In one example, for the first UE, a same beam is used to receive PSSCH/PSCCH and PSFCH at the first UE from the second UE. In one example for the first UE, different beams are used to transmit PSSCH/PSCCH and PSFCH from the first UE to the second UE. In one example, for the first UE, different beams are used to receive PSSCH/PSCCH and PSFCH at the first UE from the second UE. In one example for the first UE, different beams are used to transmit PSSCH and PSCCH from the first UE to the second UE. In one example, for the first UE, different beams are used to receive PSSCH and PSCCH at the first UE from the second UE. The roles of the first and second UEs can be interchanged.

In one example, a UE can have beam correspondence, without beam sweeping, between the transmit beam and receive beam, for example, if the transmit beam to a second UE is known, the receive beam from the second UE is also known without beam sweeping. In one example, of this disclosure, a UE can have beam correspondence, without beam sweeping, between the transmit beam and receive beam, for example, if the receive beam from a second UE is known, the transmit beam to the second UE is also known without beam sweeping. In one example, a UE performs beam sweeping to determine a receive beam from a second UE, regardless of whether or not the UE knows a transmit beam to the second UE. In one example, a UE performs beam sweeping to determine a transmit beam to a second UE, regardless of whether or not the UE knows a receive beam from the second UE. In one example, based on the previous examples, a transmit beam used for PSSCH/PSCCH to UE-B can be used to determine a receive beam for a corresponding PSFCH from UE-B, or vice versa. In one example, based on the previous examples, a receive beam used for PSSCH/PSCCH from UE-B can be used to determine a transmit beam for a corresponding PSFCH to UE-B, or vice versa.

In the present disclosure, a time occasion can correspond to a slot or a group of slots, or to a symbol or a group of symbols. A time occasion can be identified by a time occasion index.

In the present disclosure, a direct communication request (DCR) can be a message that performs link establishment e.g., sent on PSSCH/PSCCH.

In the present disclosure, without the loss of any generality, the UE-B is the UE initiating the unicast session. i.e., the UE-B is the UE that that transmits the direct communication request (illustrated in FIG. 9) to the UE-A, unless otherwise noted.

A UE transmits a beam identification (BI) signal (i.e., a signal for beam identification). The beam identification signal can include assistance information to assist in determining the beam to use when a UE transmits a direct communication request (DCR) i.e., link establishment message, or when a UE receives a DCR i.e., link establishment message, transmitted by another UE. In some embodiments, the BI transmitted by the UE can also include information about other UE's preferred transmit beams when transmitting to the UE.

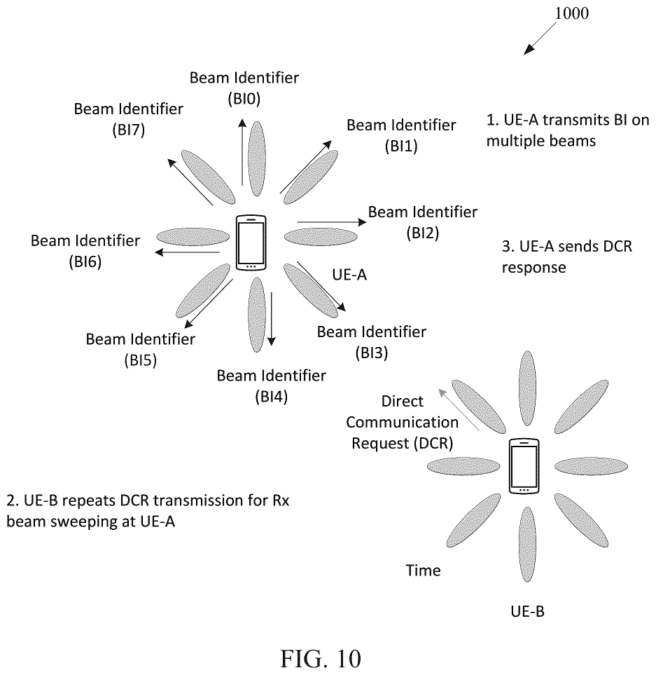

FIG. 10 illustrates an example of beam indication 1000 according to embodiments of the present disclosure. An embodiment of the beam indication 1000 shown in FIG. 10 is for illustration only.

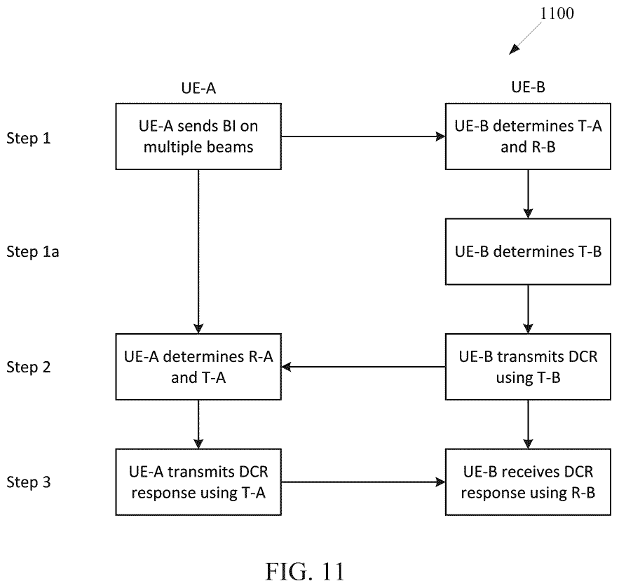

FIG. 11 illustrates a flowchart for an example method 1100 of communication between a UE-A and a UE-B according to embodiments of the present disclosure. An embodiment of the method 1100 of communication between a UE-A and a UE-B shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

In one embodiment as illustrated in FIG. 10 and FIG. 11, the UE-A transmits a BI signal. The UE-B receives the BI signal from the UE-A and determines a best or preferred receive beam (e.g., spatial domain receive filter) (e.g., denoted by R-B) when receiving from the UE-A and by beam correspondence, a best or preferred transmit beam (e.g., spatial domain transmit filter) (e.g., denoted by T-B) when transmitting to the UE-A. The UE-B transmits one or multiple DCRs to the UE-A using T-B, whereby the UE-A can determine a best or preferred receive beam (e.g., spatial domain receive filter) (e.g., denoted by R-A) when receiving from the UE-B. The UE-A can determine a best or preferred transmit beam (e.g., spatial domain transmit filter) (e.g., denoted by T-A) when transmitting to the UE-B, by beam correspondence at the UE-A or by indication (e.g., in the DCR) from the UE-B.

The procedure is further described as following examples.

In one example of Step 1 at the UE-A, the UE-A transmits BI signal on multiple UE-A transmit beams (e.g., multiple UE-A spatial domain transmission filters), e.g., transmit beam sweeping. In one example, the BI signal can include a UE identity for the UE-A. In one example, the BI signal can include an index that identifies the transmit beam (e.g., spatial domain transmission filter) of the UE-A. In another example, transmit beam (e.g., spatial domain transmission filter) of the UE-A can be determined implicitly (e.g., based on time occasion or resource) as described later in this disclosure.

In one example of Step 1 at the UE-B, the UE-B receives the BI signal from the UE-A and determines a best or preferred receive beam (e.g., spatial domain reception filter) when receiving from the UE-A (e.g., denoted as R-B). The UE-B can also determine a best or preferred transmit beam (e.g., spatial domain transmission filter) for the UE-A (e.g., denoted as T-A) when the UE-A transmits to the UE-B.

In one example of Step 1a at the UE-B, in case of beam correspondence at the UE-B, the UE-B can determine a transmit beam (e.g., spatial domain transmission filter) for the UE-B (e.g., denoted as T-B) to use when transmitting to the UE-A, based on R-B. For transmissions to the UE-A, the UE-B uses T-B. For receptions from the UE-A, the UE-B uses R-B.

In one example of Step 2 at the UE-B, the UE-B wants to establish a unicast link to the UE-A. The UE-B sends DCR using T-B. The DCR can be repeated multiple times using T-B or sent once.

In one example of Step 2 at the UE-A, the UE-A performs receive beam sweeping and determines best receive beam (e.g., spatial domain reception filter) to receive the DCR of UE-B (e.g., denoted as R-A).

In one example, the UE-A, in case of beam correspondence, determines the transmit beam (e.g., spatial domain transmission filter) (e.g., denoted as T-A) for the UE-A to transmit to the UE-B based on R-A.

In one example, the DCR from the UE-B can contain an indicator of T-A.

In one example of Step 3, the UE-A sends DCR response to the UE-B using T-A. To assist the reception of the DCR response at the UE-B: In one example, the DCR response can be repeated multiple times to allow for receive beam sweeping at the UE-B. In another example, there is a correspondence (or association) between R-B (and/or T-B) and the slot index or time occasion index or resource index. The UE-A can use this correspondence with knowledge of the T-B (and/or R-B) to transmit the DCR response on a slot or time occasion or resource associated with T-B (and/or R-B). In another example, the UE-B can indicate in the DCR the slot or slots or time occasion(s) or resource(s) in which the UE-B expects the DCR response, the UE-B uses R-B to receive the DCR response in the slot or slots or time occasion(s) or resource(s) indicated and the UE-A transmits the DCR response the slot or slots or time occasion(s) or resource(s) indicated.

For transmissions to the UE-B, the UE-A uses T-A. For receptions from the UE-B, the UE-A uses R-A.

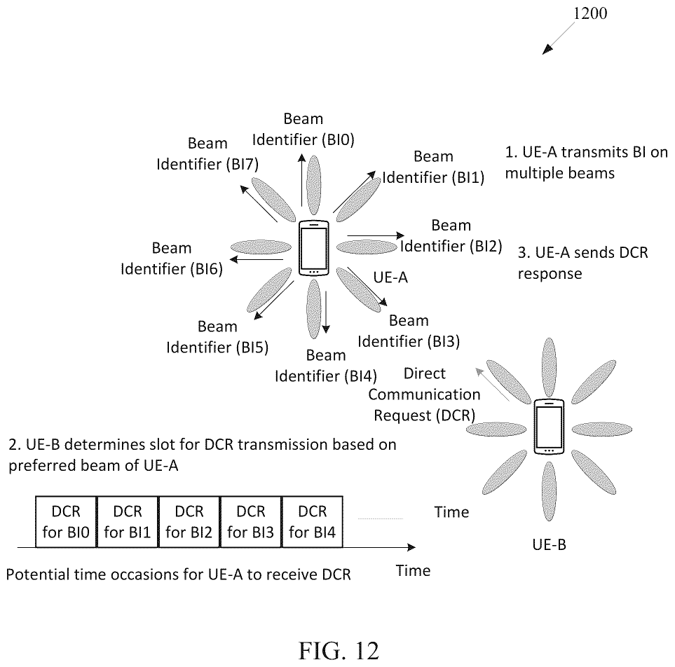

FIG. 12 illustrates another example of beam indication 1200 according to embodiments of the present disclosure. An embodiment of the beam indication 1200 shown in FIG. 12 is for illustration only.

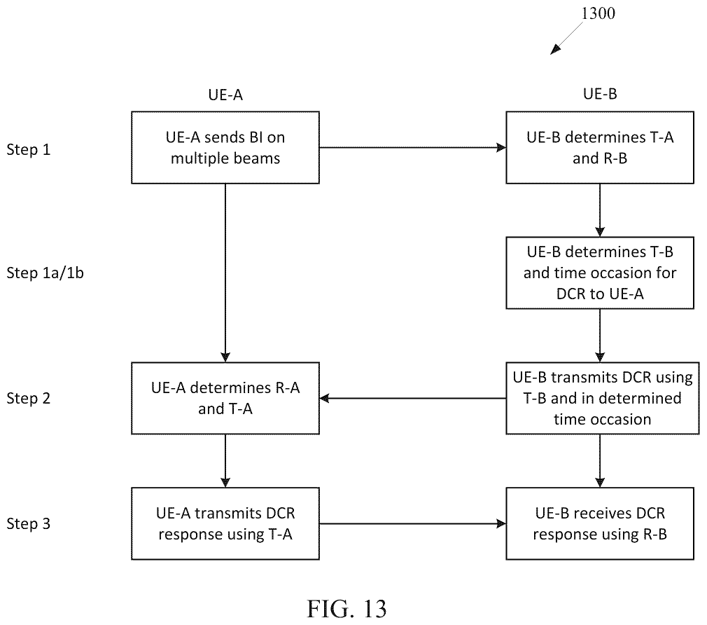

FIG. 13 illustrates a flowchart for another example method 1300 of communication between a UE-A and a UE-B according to embodiments of the present disclosure. An embodiment of the method 1300 of communication between a UE-A and a UE-B shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

In a one embodiment as illustrated in FIG. 12 and FIG. 13, the UE-A transmits a BI signal. The UE-B receives the BI signal from the UE-A and determines a best or preferred transmit beam (e.g., spatial domain transmit filter) from the UE-A to the UE-B (e.g., denoted at T-A). The UE-B also determines a best or preferred receive beam (e.g., spatial domain receive filter) (e.g., denoted by R-B) when receiving from the UE-A and by beam correspondence, a best or preferred transmit beam (e.g., spatial domain transmit filter) (e.g., denoted by T-B) when transmitting to the UE-A. There can be a correspondence between a slot index or time occasion index or resource index and the receive beam (spatial domain receive filter of UE-A). Based on T-A and assuming beam correspondence at the UE-A, the UE-B determines a slot or time occasion or resource for transmission of the DCR, in which slot or time occasion or resource UE-A uses a corresponding beam for reception. The UE-A can determine a best or preferred transmit beam (e.g., spatial domain transmit filter) (e.g., denoted by T-A) when transmitting to the UE-B, by beam correspondence at the UE-A and/or based on the slot the DCR reception and/or by indication (e.g., in the DCR) from the UE-B.

The procedure is further described as follows.

In Step 1 at the UE-A, the UE-A transmits BI signal on multiple transmit beams (e.g., multiple the UE-A spatial domain transmission filters), e.g., transmit beam sweeping. In one example, the BI signal can include a UE identity for the UE-A. In one example, the BI signal can include an index that identifies the transmit beam (e.g., spatial domain transmission filter) of the UE-A. In another example, transmit beam (e.g., spatial domain transmission filter) of the UE-A can be determined implicitly (e.g., based on time occasion or resource) as described later in this disclosure.

In Step 1 at the UE-B, the UE-B receives the BI signal from the UE-A and determines a best or preferred transmit beam (e.g., spatial domain transmission filter) for the UE-A (e.g., denoted as T-A) when transmitting to the UE-B. In the process, the UE-B determines a best or preferred receive beam (e.g., spatial domain reception filter) for the UE-B (e.g., denoted as R-B) when the UE-B is receiving from the UE-A. This establishes a beam-pair T-A/R-B for transmission from the UE-A and reception by the UE-B that is known at the UE-B.

In Step 1a at the UE-B, in case of beam correspondence at the UE-B, the UE-B can determine a transmit beam (e.g., spatial domain transmission filter) for the UE-B (e.g., denoted as T-B) to use when transmitting to the UE-A, based on R-B. For transmissions to the UE-A, the UE-B uses T-B. For receptions from the UE-A, the UE-B uses R-B.

In Step 1b at the UE-B, there is a correspondence between a receive beam (spatial domain reception filter) of the UE-A and a slot index (logical slot index or physical slot index) or time occasion index or resource index as explained in the examples of this disclosure. Upon determining T-A at the UE-B, the UE-B determines the receive beam (spatial domain reception filter) the UE-A uses to receive from the UE-B, when there is beam correspondence at the UE-A (e.g., denoted by R-A). Based on the aforementioned correspondence between R-A and a slot index or time occasion index or resource index, the UE-B determines the slot index or time occasion index or resource index of a transmission to the UE-A. During which slot or time occasion or resource the UE-A is receiving using R-A and is able to receive the transmission from the UE-B.

In Step 2 at the UE-B, the UE-B wants to establish a unicast link to the UE-A. the UE-B sends DCR using T-B in a slot or time occasion or resource corresponding to or associated with R-A. In one example, the DCR can include an indication of T-A (the transmit beam or spatial domain transmission filter) to be used by the UE-A when transmitting to the UE-B. In another example, the DCR does not include an indication of T-A, T-A can be determined implicitly, e.g., based on the slot index or time occasion index or resource index of the DCR.

In Step 2 at the UE-A, upon receiving the DCR in a slot or time occasion or resource corresponding to or associated with R-A (and/or T-A), the UE-A receives the DCR using R-A. the UE-A can determine the beam T-A to use for transmission from the UE-B and the beam R-A to use for receptions from the UE-B.

In Step 3, the UE-A sends DCR response to the UE-B using T-A. To assist the reception of the DCR response at the UE-B: In one example, the DCR response can be repeated multiple times to allow for receive beam sweeping at the UE-B. In another example, there is a correspondence (or association) between R-B (and/or T-B) and the slot index or time occasion index or resource index. the UE-A can use this correspondence with knowledge of the T-B (and/or R-B) to transmit the DCR response on a slot or time occasion or resource associated with T-B (and/or R-B). In another example, the UE-B can indicate in the DCR the slot or slots or time occasion(s) or resource(s) in which the UE-B expects the DCR response, the UE-B uses R-B to receive the DCR response in the slot or slots or time occasion(s) or resource(s) indicated and the UE-A transmits the DCR response the slot or slots or time occasion(s) or resource(s) indicated.

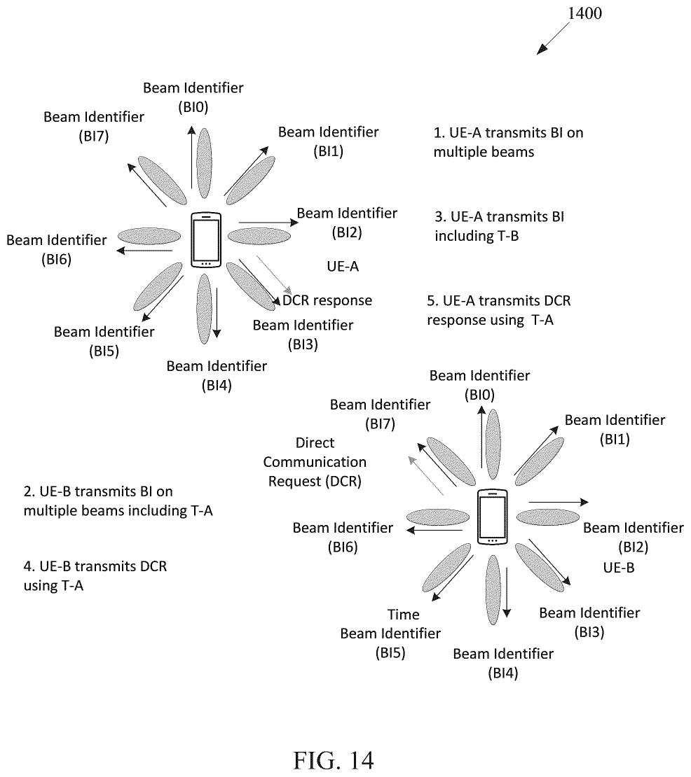

FIG. 14 illustrates yet another example of beam indication 1400 according to embodiments of the present disclosure. An embodiment of the beam indication 1400 shown in FIG. 14 is for illustration only.

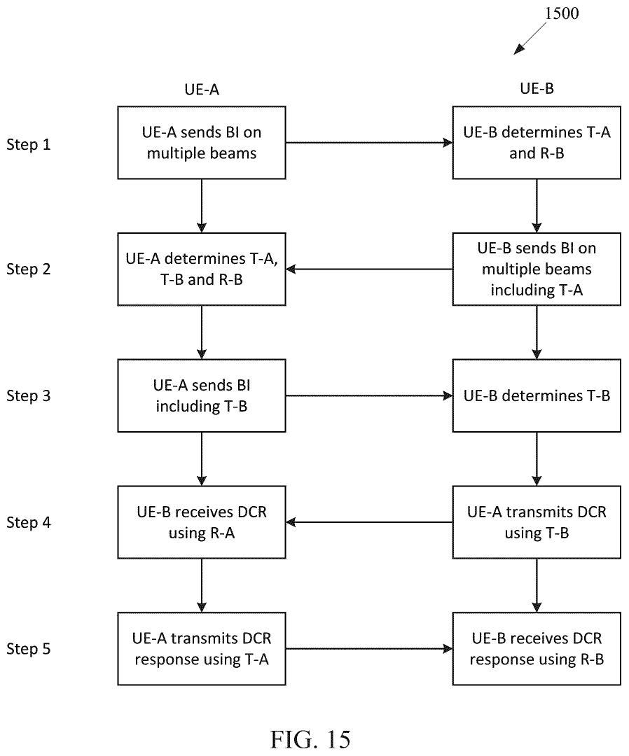

FIG. 15 illustrates a flowchart for yet another example method 1500 of communication between a UE-A and a UE-B according to embodiments of the present disclosure. An embodiment of the method 1500 of communication between a UE-A and a UE-B shown in FIG. 15 is for illustration only. One or more of the components illustrated in FIG. 15 can be implemented in specialized circuitry configured to perform the noted functions or one or more of the components can be implemented by one or more processors executing instructions to perform the noted functions.

In a one embodiment as illustrated in FIG. 14 and FIG. 15, the UE-A transmits a BI signal. The UE-B receives the BI signal from the UE-A and determines a best or preferred transmit beam (e.g., spatial domain transmit filter) from the UE-A to the UE-B (e.g., denoted at T-A). The UE-B also determines a best or preferred receive beam (e.g., spatial domain receive filter) (e.g., denoted by R-B) when receiving from the UE-A. The UE-B transmits a BI signal (or a response signal), the BI signal (or response signal) from the UE-B can include information about T-A (i.e., the preferred or best transmit beam or spatial domain transmit filter from transmission from the UE-A to the UE-B).

In a further example, the response signal can additionally include information about R-B or the slots or subframes or symbols or resources or time occasions, in which the UE-B receives using R-B. In one example, a UE-A receives the BI signal of the UE-B and determines a best or preferred transmit beam (e.g., spatial domain transmit filter) from the UE-B to the UE-A (e.g., denoted at T-B). In one example, when a UE-A receives the BI signal or the response signal, the UE-A also determines a best or preferred receive beam (e.g., spatial domain receive filter) (e.g., denoted by R-A) when receiving from the UE-A. In one example, a UE-A is also informed of T-A (transmit beam or spatial domain transmission filter when transmitting to the UE-B) in the BI reference signal or response signal from the UE-B. In one example, after the UE-A receives the response signal, and if it has a link establishment message to send to the UE-B, the UE-A uses the beam T-A to send the message in a slot or time occasion or resource associated with beam R-B as determined by the response signal. In one example, the UE-A transmits a BI signal or response that further includes information about T-B (i.e., the preferred or best transmit beam or spatial domain transmit filter from transmission from the UE-A to the UE-B).

In one example, the UE-B receives the BI signal of the UE-A and is informed of its T-A for communicating with the UE-A.

The procedure is further described as follows.

In Step 1 at the UE-A, the UE-A transmits BI signal on multiple the UE-A transmit beams (e.g., multiple the UE-A spatial domain transmission filters), e.g., transmit beam sweeping. In one example, the BI signal can include a UE identity for the UE-A. In one example, the BI signal can include an index that identifies the transmit beam (e.g., spatial domain transmission filter) of the UE-A. In another example, transmit beam (e.g., spatial domain transmission filter) of the UE-A can be determined implicitly (e.g., based on time occasion or resource) as described later in this disclosure. In one example, the BI signal can additionally include information about slots or time occasions or resources associated with a receive beam (or spatial domain reception filter) at the UE-A corresponding to the transmit beam used for the BI signal, in a further example this association is determined implicitly (e.g., based on slot or time occasion or resource numbering without further signaling).

In Step 1 at the UE-B, the UE-B receives the BI signal from the UE-A and determines a best or preferred transmit beam (e.g., spatial domain transmission filter) for the UE-A (e.g., denoted as T-A) when transmitting to the UE-B. In the process, the UE-B determines a best or preferred receive beam (e.g., spatial domain reception filter) for the UE-B (e.g., denoted as R-B) when the UE-B is receiving from the UE-A. This establishes a beam-pair T-A/R-B for transmission from the UE-A and reception by the UE-B that is known at the UE-B.

In Step 2 at the UE-B, the UE-B transmits BI signal (or response signal) on multiple UE-B transmit beams (e.g., multiple UE-B spatial domain transmission filters), e.g., transmit beam sweeping. In a variant example, the UE-B transmits BI signal (or response signal) on a beam T-B, wherein T-B is determined based on R-B and assuming beam correspondence at the UE-B. In one example, the BI signal (or response signal) includes information about or is determine by the UE-A (e.g., UE-A index or identity or source ID or destination ID) and T-A which is the best or preferred beam for the UE-A to use when transmitting to the UE-B. In one example, assistance information included in or indicated by the BI signal or the response signal (BI response) as explained in the following examples. In one example, the BI signal (or response signal) can include or is determine by a UE identity for the UE-B. In one example, the BI signal can include or is determined by an index that identifies the transmit beam (e.g., spatial domain transmission filter) of UE-A. In another example, transmit beam (e.g., spatial domain transmission filter) of UE-A can be determined implicitly (e.g., based on time occasion or resource) as described later in this disclosure. In one example, the BI signal or response signal can additionally include information about slots or time occasions or resources associated with a receive beam (or spatial domain reception filter) at the UE-B corresponding to the transmit beam used for the BI signal or response, in a further example this association is determined implicitly (e.g., based on slot or time occasion or resource numbering without further signaling).

In Step 2 at the UE-A, the UE-A receives the BI signal or response signal from the UE-B and determines a best or preferred transmit beam (e.g., spatial domain transmission filter) for the UE-B (e.g., denoted as T-B) when transmitting to the UE-A. In the process, the UE-A determines a best or preferred receive beam (e.g., spatial domain reception filter) for the UE-A (e.g., denoted as R-A) when the UE-A is receiving from the UE-B. This establishes a beam-pair T-B/R-A for transmission from the UE-B and reception by the UE-A that is known at the UE-A.

When the UE-A receives the BI signal or response signal from the UE-B, the UE-A is informed (e.g., based on assistance information) or can determine the best or preferred beam T-A to use when transmitting to the UE-B.

In Step 3 at the UE-A, the UE-A transmits BI signal, or response signal, on multiple the UE-A transmit beams (e.g., multiple UE-B spatial domain transmission filters), e.g., transmit beam sweeping, or on a single beam using T-A. The BI additionally includes information about or is determined by the UE-B (e.g., UE-B index or identity or source ID or destination ID) and T-B which is the best or preferred beam for the UE-B to use when transmitting to the UE-A.

In Step 3 at the UE-B, when the UE-B receives the BI signal or response signal from the UE-A, the UE-B is informed or can determine the best or preferred beam T-B to use when transmitting to the UE-A.

In case of beam correspondence at the UE-A the knowledge of R-A can help the UE-A determine T-A or vice versa, the knowledge of T-A can help the UE-A determine R-A.

In case of beam correspondence at the UE-B the knowledge of R-B can help the UE-B determine T-B or vice versa, the knowledge of T-B can help the UE-B determine R-B.

In one example, step 3 can be optional. For example, after the UE-A has received the response message in step 2, the UE-A is informed of (1) the transmit beam (or spatial domain transmission filter) T-A to use when transmitting to the UE-B, and (2) receive beam (or spatial domain reception filter) R-B at the UE-B, or the slots or time occasion or resource associated with the receive beam (or spatial domain reception filter) R-B at the UE-B. There can be an association configured or specified or determined between R-B and slot or time occasion or resource indices in which the UE-B uses Re-B. the UE-A can send a link establishment message (e.g., DCR) (e.g., as described in step 5) to the UE-B using T-A and in the slots associated with R-B

In Step 4, when the UE-B has a transmission to the UE-A (e.g., DCR or link establishment message), the UE-B can use T-B to transmit to the UE-A. To assist the reception of the DCR at the UE-A: In one example, the DCR can be repeated multiple times to allow for receive beam sweeping at the UE-A. In another example, there is a correspondence (or association) between R-A (and/or T-A) and the slot or time occasion or resource index. The UE-B can use this correspondence with knowledge of the T-A (and/or R-A) to transmit the DCR on a slot or time occasion or resource associated with T-A (and/or R-A). In one example, step 4, is optional and the link establishment message is sent from UE-A as described in steps 3/5.

In Step 5, when the UE-A has a transmission to the UE-B (e.g., DCR or response to DCR), the UE-A can use T-A to transmit to the UE-B. To assist the reception of the DCR or DCR response at the UE-B: In one example, the DCR or DCR response can be repeated multiple times to allow for receive beam sweeping at the UE-B. In another example, there is a correspondence (or association) between R-B (and/or T-B) and the slot or time occasion or resource index. The UE-A can use this correspondence with knowledge of the T-B (and/or R-B) to transmit the DCR or DCR response on a slot or time occasion or resource associated with T-B (and/or R-B). In another example, the UE-B can indicate in the DCR or the BI response in step 2 the slot or slots or time occasion(s) or resource(s) in which the UE-B expects the DCR or DCR response, the UE-B uses R-B to receive the DCR or DCR response in the slot or slots or time occasion(s) or resource(s) indicated and the UE-A transmits the DCR or DCR response the slot or slots or time occasion(s) or resource(s) indicated.

In the following examples, a beam indication signal transmitted in slot n₁ and/or symbol n₂ and/or resource n₃ and/or time occasion n₄ in a beam direction can be associated with reception in the same beam direction (e.g., when there is beam correspondence), in slot m₁ and/or symbol m₂ and/or resource m₃ and/or time occasion m₄, wherein n₁, n₂, n₃ and/or n₄ and m₁, m₂, m₃ and/or m₄ are related by a function or a relation that can be (pre-)configured and/or specified in the system specifications.

In one example, a UE (e.g., UE-A or UE-B) transmits a BI signal on multiple UE (e.g., UE-A or UE-B) transmit beams (e.g., multiple UE (e.g., UE-A or UE-B) spatial domain transmission filters), e.g., the UE (e.g., UE-A or UE-B) performs transmit beam sweeping.

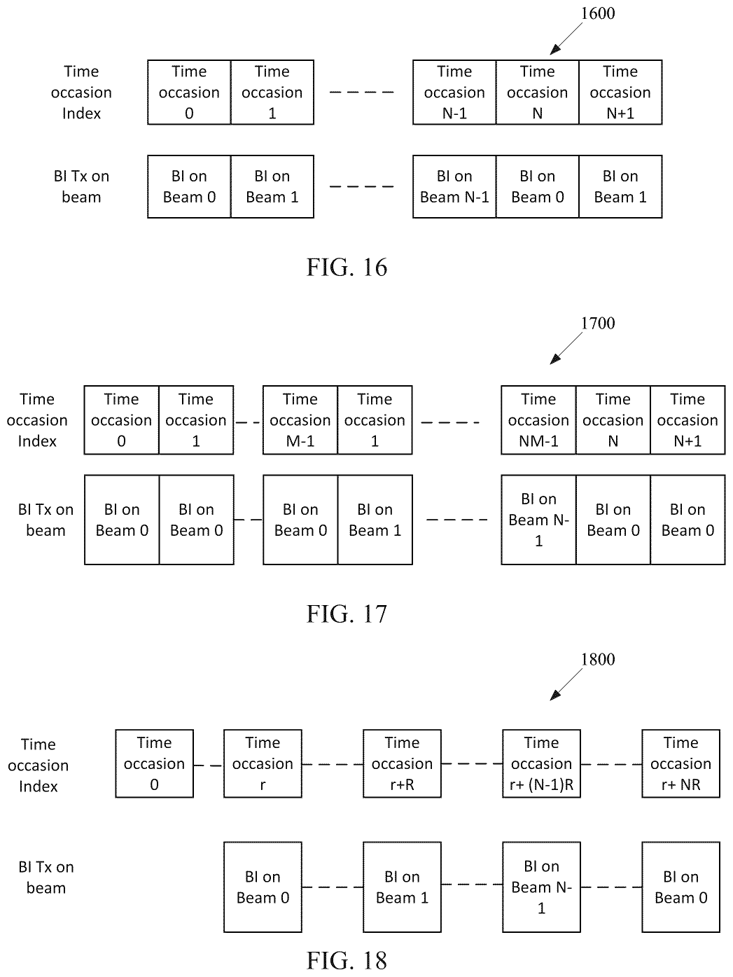

FIG. 16 illustrates an example of time occasion or resource index determination 1600 according to embodiments of the present disclosure. An embodiment of the time occasion or resource index determination 1600 shown in FIG. 16 is for illustration only.

In one example, a slot or time occasion or resource index determines or is linked to a UE transmit beam (e.g., UE spatial domain transmission filter). In one example, the slot index is a physical slot index. In one example, the slot index is a logical slot index within the resource pool. In one example, illustrated in FIG. 16, if there are N UE transmit beams (e.g., UE spatial domain transmission filters), 0, 1, . . . , N−1, a BI transmitted in a slot or time occasion or resource with index m, is transmitted on beam (e.g., spatial domain transmission filter) n, such that m % N=n. Where % is the modulo operator that determines the remainder after dividing m by N. In one example, N can be pre-configured, and/or configured or updated by RRC signaling from a network and/or RRC signaling over PC5 and/or MAC CE signaling and L1 control signaling. In one example, N can be specified in the system specifications.

In one example, if N is not (pre-)configured, a default value specified in the system specification is used. In one example, if the number of transmit beams T is less than N, the UE leaves some (N−T) occasions per beam sweep cycle unused. In one example, if the number of transmit beams T is less than N, the UE can use more than one occasion per beam sweep cycle for a transmit beam. In one example, whether to leave some occasions unused per beam sweep cycle or repeat a transmit beam in multiple occasions per beam sweep cycle, can be (pre-)configured or left to the UE's implementation. In one example, if the number of transmit beams T is equal to N, a UE maps a transmit beam to one occasion each beam sweep cycle. In one example, if the number of transmit beams T is more than N, the UE selects N transmit beams to map to the N occasions per beam sweep cycle. In one sub-example, the same N transmit beams are used in each beam sweep cycle. In one sub-example, different N transmit beams can be used in each beam sweep cycle.

FIG. 17 illustrates another example of time occasion or resource index determination 1700 according to embodiments of the present disclosure. An embodiment of the time occasion index determination 1700 shown in FIG. 17 is for illustration only.

In one example, illustrated in FIG. 17, if there are N UE transmit beams (e.g., UE-A spatial domain transmission filters), 0, 1, . . . , N−1, a BI signal transmitted in a slot or time occasion or resource with index m, is transmitted on beam (e.g., spatial domain transmission filter) n, such that

$$⌊ \frac{m}{M} ⌋ \% N = n .$$

Where % is the modulo operator that determines the remainder after dividing [symbol] by N. Where, M is the number of slots or time occasions or resources a BI signal can be repeated on with the same beam. M can be pre-configured, and/or configured or updated by RRC signaling from a network and/or RRC signaling over PC5 and/or MAC CE signaling and L1 control signaling. In one example, M can be specified in the system specifications. In one example, if M is not (pre-)configured, a default value specified in the system specification is used. The repetition of the BI signal in multiple slots or time occasions or resources with the same UE transmit beam (e.g., UE spatial domain transmission filter) can be used for spatial domain receive filter sweeping at the UE receiving the BI signal, i.e., for the receiving UE to refine its receive beam for a transmission from transmitting UE. N can be pre-configured, and/or configured or updated by RRC signaling from a network and/or RRC signaling over PC5 and/or MAC CE signaling and L1 control signaling. In one example, N can be specified in the system specifications.

In one example, if N is not (pre-)configured, a default value specified in the system specification is used. In one example, if the number of transmit beams T is less than N, the UE leaves some (N−T)×M occasions per beam sweep cycle unused. In one example, if the number of transmit beams T is less than N, the UE can use more than M occasion per beam sweep cycle for a transmit beam. In one example, whether to leave some occasions unused per beam sweep cycle or repeat a transmit beam in multiple occasions per beam sweep cycle, can be (pre-)configured or left to the UE's implementation. In one example, if the number of transmit beams T is equal to N, a UE maps a transmit beam to M occasions each beam sweep cycle. In one example, if the number of transmit beams T is more than N, the UE selects N transmit beams to map to the N×M occasions per beam sweep cycle. In one sub-example, the same N transmit beams are used in each beam sweep cycle. In one sub-example, different N transmit beams can be used in each beam sweep cycle.

FIG. 18 illustrates yet another example of time occasion or resource index determination 1800 according to embodiments of the present disclosure. An embodiment of the time occasion index determination 1800 shown in FIG. 18 is for illustration only.

In one example, illustrated in FIG. 18, if there are N UE transmit beams (e.g., UE spatial domain transmission filters), 0, 1, . . . , N−1, a BI signal transmitted in a slot or time occasion or resource with index m, is transmitted on beam (e.g., spatial domain transmission filter) n, such that

$$( m - r ) \% R = 0 and ( \frac{m - r}{R} ) \% N = n .$$

Where % is the modulo operator that determines the remainder after dividing

$$( \frac{m - r}{R} )$$

by N. R can be pre-configured, and/or configured or updated by RRC signaling from a network and/or RRC signaling over PC5 and/or MAC CE signaling and L1 control signaling. In one example, R can be specified in the system specifications. In one example, if R is not (pre-)configured, a default value specified in the system specification is used. r can be pre-configured, and/or configured or updated by RRC signaling from a network and/or RRC signaling over PC5 and/or MAC CE signaling and L1 control signaling.

In one example, r can be specified in the system specifications, e.g., r=0. In one example, if r is not (pre-)configured, a default value specified in the system specification is used, e.g., r=0. N can be pre-configured, and/or configured or updated by RRC signaling from a network and/or RRC signaling over PC5 and/or MAC CE signaling and L1 control signaling. In one example, N can be specified in the system specifications. In one example, if N is not (pre-)configured, a default value specified in the system specification is used. In one example, if the number of transmit beams T is less than N, the UE leaves some (N−T) occasions per beam sweep cycle unused. In one example, if the number of transmit beams T is less than N, the UE can use more than one occasion per beam sweep cycle for a transmit beam. In one example, whether to leave some occasions unused per beam sweep cycle or repeat a transmit beam in multiple occasions per beam sweep cycle, can be (pre-)configured or left to the UE's implementation.

In one example, if the number of transmit beams T is equal to N, a UE maps a transmit beam to one occasion each beam sweep cycle. In one example, if the number of transmit beams T is more than N, the UE selects N transmit beams to map to the N occasions per beam sweep cycle. In one sub-example, the same N transmit beams are used in each beam sweep cycle. In one sub-example, different N transmit beams can be used in each beam sweep cycle.

In one example, a most recent S-SSB transmission determines or is linked to a UE-A transmit beam (e.g., UE-A spatial domain transmission filter). A SL UE receives or transmits the following SL synchronization signals and broadcast channel: (1) SL primary synchronization signal (S-PSS), (2) SL secondary synchronization signal (S-SSS), and (3) physical SL broadcast channel (PSBCH). The UE assumes that reception occasions of a PSBCH, S-PSS and S-SSS are in consecutive symbols and forms a S-SS/PSBCH block (S-SSB). The UE is provided, by higher layer parameter sl-NumSSB-WithinPeriod, a number of N_{period}^{S-SSB} S-SSBs in a period of 16 frames.

Where the allowed values for sl-NumSSB-WithinPeriod (N_{period}^{S-SSB}), depends on the frequency range and the sub-carrier spacing (SCS): (1) for FR1 and SCS=15 kHz, N_{period}^{S-SSB}∈{1}; (2) for FR1 and SCS=30 kHz, N_{period}^{S-SSB}∈{1, 2}; (3) for FR1 and SCS=60 kHz, N_{period}^{S-SSB}∈{1, 2, 4}; (4) for FR2 and SCS=60 kHz, N_{period}^{S-SSB}∈{1, 2, 4,8,16, 32}; and (5) for FR2 and SCS=120 kHz, N_{period}^{S-SSB}∈{1, 2, 4, 6,16, 32, 64}.

The transmission of the S-SSBs of the period is with a periodicity of 16 frames. The index of slots used for the transmission of SSBs with index i_{S-SSB}∈{(0, 1, . . . , N_{period}^{S-SSB}−1} are determined by: N_{offset}^{S-SSB}+(Nᵢₙₜₑᵣᵥₐₗ^{S-SSB}+1). i_{S-SSB} Where: (1) slot index 0, corresponds to the first slots of frame with (SFN mod 16)=0, or (DFN mod 16)=0; (2) N_{offset}^{S-SSB} is given by higher layer parameter sl-TimeOffsetSSB, which is in the range {0, 1, . . . , 1279}; and (3) Nᵢₙₜₑᵣᵥₐₗ^{S-SSB} is given by higher layer parameter which is in the range {0,1, . . . , 639}. In the following, a first Tx beam can be used for S-SSB0, a second Tx beam can be used for S-SSB1, etc.

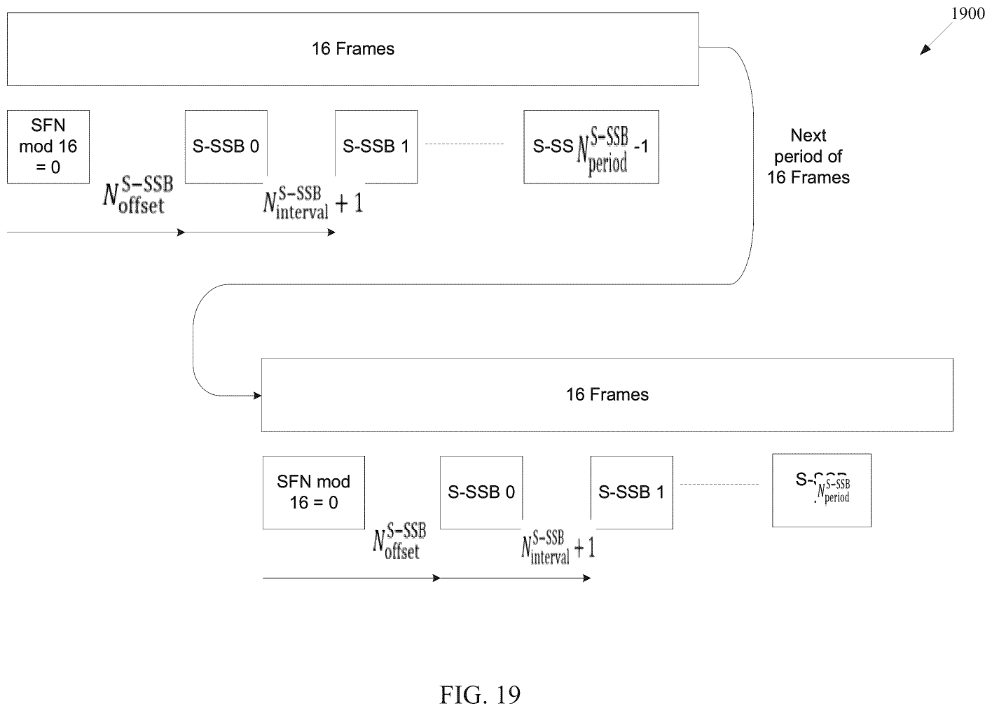

FIG. 19 illustrates another example of S-SSBs 1900 according to embodiments of the present disclosure. An embodiment of the S-SSBs 1900 shown in FIG. 19 is for illustration only.

In one example, a beam indication signal between S-SSB 0 and S-SSB 1 is associated with or linked to a first UE-A Tx beam (e.g., a first UE-A spatial domain transmission filter), a beam indication signal between S-SSB 1 and S-SSB 2 is associated with or linked to a second UE-A Tx beam (e.g., a second UE-A spatial domain transmission filter), . . . , a beam indication signal between -SSB N_{period}^{S-SSB}−2 and N_{period}^{S-SSB}−1 is associated with or linked to a (N_{period}^{S-SSB}−1) UE-A Tx beam (e.g., a (N_{period}^{S-SSB}−1)UE-A spatial domain transmission filter), a beam indication signal after S-SSB N_{period}^{S-SSB}−1 and before S-SSB 0 of the next 16-frame period is associated with or linked to a N_{period}^{S-SSB} UE-A Tx beam (e.g., a N_{period}^{S-SSB} UE-A spatial domain transmission filter). In a variant, the association is based on the slots before S-SSB.

In one example, a beam indication signal between S-SSB 0 and S-SSB 1 is associated with or linked to a first UE-A Tx beam (e.g., a first UE-A spatial domain transmission filter), a beam indication signal transmission between S-SSB 1 and S-SSB 2 is associated with or linked to a second UE-A Tx beam (e.g., a second UE-A spatial domain transmission filter), . . . , a beam indication signal between S-SSB N_{period}^{S-SSB}−2 and S-SSB N_{period}^{S-SSB}−1 is associated with or linked to a (N_{period}^{S-SSB}−1) UE-A Tx beam (e.g., a (N_{period}^{S-SSB}−1)UE-A spatial domain transmission filter), a beam indication signal after S-SSB N_{period}^{S-SSB}−1 and before the end of the 16-frame period is associated with or linked to a N_{period}^{S-SSB} UE-A Tx beam (e.g., a N_{period}^{S-SSB} UE-A spatial domain transmission filter). In a variant, the association is based on the slots before S-SSB.

In one example, a beam indication signal between S-SSB 0 and S-SSB 1 is associated with or linked to a first UE-A Tx beam (e.g., a first UE-A spatial domain transmission filter), a beam indication signal between S-SSB 1 and S-SSB 2 is associated with or linked to a second UE-A Tx beam (e.g., a second UE-A spatial domain transmission filter), . . . , a beam indication signal between S-SSB N_{period}^{S-SSB}−2 and S-SSB N_{period}^{S-SSB}−1 is associated with or linked to a (N_{period}^{S-SSB}−1) UE-A Tx beam (e.g., a (N_{period}^{S-SSB}−1) UE-A spatial domain transmission filter), a beam indication signal after S-SSB N_{period}^{S-SSB}−1 and for Nᵢₙₜₑᵣᵥₐₗ^{S-SSB} slots from S-SSB N_{period}^{S-SSB}−1 is associated with or linked to a N_{period}^{S-SSB} UE-A Tx beam (e.g., a N_{period}^{S-SSB} UE-A spatial domain transmission filter). In a variant, the association is based on the slots before S-SSB.

In one example, a beam indication signal after S-SSB 0 and before S-SSB 1 and for no more than K slots starting from S-SSB 0 is associated with or linked to a first UE-A Tx beam (e.g., a first UE-A spatial domain transmission filter), a beam indication signal after S-SSB 1 and before S-SSB 2 and for no more than K slots starting from S-SSB 1 is associated with or linked to a second UE-A Tx beam (e.g., a second UE-A spatial domain transmission filter), . . . , a beam indication signal after S-SSB N_{period}^{S-SSB}−2 and before S-SSB N_{period}^{S-SSB}−1 and for no more than K slots starting from S-SSB N_{period}^{S-SSB}−2 is associated with or linked to a (N_{period}^{S-SSB}−1) UE-A Tx beam (e.g., a (N_{period}^{S-SSB}−1)UE-A spatial domain transmission filter), a beam indication signal after S-SSB N_{period}^{S-SSB}−1 and before S-SSB 0 of next 16-frame interval and for no more than K slots starting from S-SSB N_{period}^{S-SSB}−1 is associated with or linked to a N_{period}^{S-SSB} UE-A Tx beam (e.g., a N_{period}^{S-SSB} UE-A spatial domain transmission filter). In one example, K is in units of logical slots in a resource pool.

In one example, K is in units of physical slots. In one example, K is in symbols. In one example, K is in time occasions. K can be pre-configured, and/or configured or updated by RRC signaling from a network and/or RRC signaling over PC5 and/or MAC CE signaling and L1 control signaling. In one example, K can be specified in the system specifications, for example K=1 or K=2. In one example, if K is not (pre-)configured, a default value specified in the system specification is used for example K=1 or K=2. In one example, K is the same for all S-SSBs. In one example, a different K can be configured for each S-SSB or for some of the S-SSBs. In a variant, the association is based on the slots before S-SSB.

In one example, a beam indication signal after S-SSB 0 and before S-SSB 1 and for no more than K slots starting from S-SSB 0 is associated with or linked to a first UE-A Tx beam (e.g., a first UE-A spatial domain transmission filter), a beam indication signal after S-SSB 1 and before S-SSB 2 and for no more than K slots starting from S-SSB 1 is associated with or linked to a second UE-A Tx beam (e.g., a second UE-A spatial domain transmission filter), . . . , a beam indication signal after S-SSB N_{period}^{S-SSB}−2 and before S-SSB N_{period}^{S-SSB}−1 and for no more than K slots starting from S-SSB N_{period}^{S-SSB}−2 is associated with or linked to a (N_{period}^{S-SSB}−1) UE-A Tx beam (e.g., a (N_{period}^{S-SSB}−1)UE-A spatial domain transmission filter), a beam indication signal after S-SSB N_{period}^{S-SSB}−1 and before the end of the 16-frame interval and for no more than K slots starting from S-SSB N_{period}^{S-SSB}−1 is associated with or linked to a N_{period}^{S-SSB} UE-A Tx beam (e.g., a N_{period}^{S-SSB} UE-A spatial domain transmission filter).

In one example, K is in units of logical slots in a resource pool. In one example, K is in units of physical slots. In one example, K is in symbols. In one example, K is in time occasions. K can be pre-configured, and/or configured or updated by RRC signaling from a network and/or RRC signaling over PC5 and/or MAC CE signaling and L1 control signaling. In one example, K can be specified in the system specifications, for example K=1 or K=2. In one example, if K is not (pre-)configured, a default value specified in the system specification is used for example K=1 or K=2. In one example, K is the same for all S-SSBs. In one example, a different K can be configured for each S-SSB or for some of the S-SSBs. In a variant, the association is based on the slots before S-SSB.

In one example, a beam indication signal after S-SSB 0 and for no more than K slots starting from S-SSB 0 is associated with or linked to a first UE-A Tx beam (e.g., a first UE-A spatial domain transmission filter), a beam indication signal after S-SSB 1 and for no more than K slots starting from S-SSB 1 is associated with or linked to a second UE-A Tx beam (e.g., a second UE-A spatial domain transmission filter), . . . , a beam indication signal after S-SSB N_{period}^{S-SSB}−2 and for no more than K slots starting from S-SSB N_{period}^{S-SSB}−2 is associated with or linked to a (N_{period}^{S-SSB}−1) UE-A Tx beam (e.g., a (N_{period}^{S-SSB}−1) UE-A spatial domain transmission filter), a beam indication signal after S-SSB N_{period}^{S-SSB}−1 and for no more than K slots starting from S-SSB N_{period}^{S-SSB}−1 is associated with or linked to a N_{period}^{S-SSB} UE-A Tx beam (e.g., a N_{period}^{S-SSB} UE-A spatial domain transmission filter).

In one example, K is in units of logical slots in a resource pool. In one example, K is in units of physical slots. In one example, K is in symbols. In one example, K is in time occasions. K can be pre-configured, and/or configured or updated by RRC signaling from a network and/or RRC signaling over PC5 and/or MAC CE signaling and L1 control signaling. In one example, K can be specified in the system specifications, for example K=1 or K=2. In one example, if K is not (pre-)configured, a default value specified in the system specification is used for example K=1 or K=2. In one example, K is the same for all S-SSBs. In one example, a different K can be configured for each S-SSB or for some of the S-SSBs. In a variant, the association is based on the slots before S-SSB.

In one example, a parameter (value) (e.g., beam index or parameter indicating or is associated with beam index) is included in the BI signal, wherein the parameter (value) determines or is linked to a UE-A transmit beam (e.g., UE-A spatial domain transmission filter). In one example, the parameter (value) can be a UE transmit beam (e.g., UE spatial domain transmission filter) index.

In one example, the parameter (value) is a field in a first stage SCI in a PSCCH channel associated with the BI signal.

In one example, the parameter (value) is a field in a second stage SCI in a PSSCH channel associated with the BI signal.

In one example, the parameter (value) is a field in a SL shared channel (SL-SCH) in a PSCCH channel associated with the BI signal.

In one example, the parameter (value) is a field in MAC CE associated with the BI signal.

In one example, a BI signal includes (or is) a CSI-RS. In one example, a CSI-RS can include and/or indicate a UE-ID. In one example, a CSI-RS can include and/or indicate a beam ID or a parameter associated, or linked to a beam ID.

In one example, the sequence of the CSI-RS resource is generated according to

$$r ( m ) = \frac{1}{\sqrt{2}} ( 1 - 2 c ( 2 m ) ) + j \frac{1}{\sqrt{2}} ( 1 - 2 c ( 2 m + 1 ) ) where , m = 0 , 1 , …$$

The pseudo-random sequence c(n) is a length-31 Gold sequence defined as c(n)=(x₁(n+N_{c})+x₂(n+N_{c})) mod 2 where: (1) N_{c}=1600; (2) x₁(n+31)=(x₁(n+3)+x₁(n)) mod 2; and (3) x₁(n+31)=(x₂(n+3)+x₂(n+2)+x₂(n+1)+x₂(n)) mod 2.

The first m-sequence is initialized with x₁(0)=1, and x₂(n)=0, for n=1 . . . 30.

The second m-sequence is initialized with cᵢₙᵢₜ, where cᵢₙᵢₜ: cᵢₙᵢₜ=(2¹⁰ (N_{symb}^{slot}n_{s,f}^{μ}, +l+1)(2n_{ID}+1)+n_{ID}) mod 2³¹ where: (1) N_{symb}^{slot} is the number of symbols in a slot; (2) n_{s,f}^{μ}, is the slot number within a frame for sub-carrier spacing configuration μ; (3) l is the OFDM symbol number in a slot; and (4) n_{ID}=N_{ID}^{x} mod 2¹⁰, where N_{ID}^{x} is the decimal representation of CRC of the first stage SL control information carried on PSCCH.

In one example, the sequence of the CSI-RS resource is same for all the transmitting UE transmit beams (e.g., the transmitting UE spatial domain transmission filters).

In one example, the sequence of the CSI-RS resource depends on (is a function of) the transmitting UE transmit beam index (e.g., the transmitting UE spatial domain transmission filter index). In one example, the sequence n_{ID} depends on the transmitting UE transmit beam index (e.g., the transmitting UE spatial domain transmission filter index). In one example, the equation for cᵢₙᵢₜ depends on the transmitting UE transmit beam index (e.g., the transmitting UE spatial domain transmission filter index). In one example, the CSI-RS resource has a sequence that is a function of the slot number within a frame and a symbol number as aforementioned and/or time occasion and/or resource, the slot number and/or symbol and/or time occasion and/or resource determine or imply the beam (or spatial filter) ID based on a mapping between the slot/symbol/time occasion/resource index and the beam (or spatial filter) ID.

In one example, a BI signal for a first UE (e.g., UE-A) to a second UE (e.g., UE-B) does not implicitly or explicitly indicate to the UE-B a UE-A transmit beam index (UE-A spatial domain transmission filter). A BI signal from a UE-A is transmitted on multiple beams. A response to a particular transmission instance of the BI signal allows UE-A to infer the UE-A transmit beam index (UE-A spatial domain transmission filter) for subsequent transmissions from the UE-A to the UE-B based on the transmission instance of the BI signal for which the UE-A received a response from the UE-B.

In further example, the response of the BI signal transmitted from the UE-B to the UE-A includes a signal quality indicator and/or metrics associated therewith (e.g., SL RSRP or SL-SINR as measured by the UE-B). For determining the UE-A transmit beam index (UE-A spatial domain transmission filter), the UE-A can select a transmission instance with the best (e.g., largest) signal quality indicator (e.g., SL RSRP or SL SINR). Alternatively, the UE-A can select any transmission instance with SL RSRP that exceeds a SL RSRP threshold or a SL SINR threshold. The SL RSRP threshold or SL SINR threshold can be pre-configured, and/or configured or updated by RRC signaling from a network and/or RRC signaling over PC5 and/or MAC CE signaling and L1 control signaling. In one example, if a SL RSRP threshold or SL SINR threshold is not (pre-)configured, a default value specified in the system specification is used.

In one example, the SL RSRP threshold or SL SINR threshold depends on the priority of the corresponding BI signal. In one example the SL RSRP can be based on PSCCH DMRS RSRP or PSSCH DMRS RSRP. In one example, the SL SINR can be based on PSCCH DMRS SINR or PSSCH DMRS SINR. In a further example, the response of the BI signal transmitted from the UE-B to the UE-A includes the corresponding resource or resources or time occasion(s) used for the BI signal from the UE-A, for example, the starting (or ending) time resource (e.g., slot and/or symbol—this can be absolute or relative to the response) and/or the starting (or ending) frequency resource (e.g., sub-channel and/or PRB and/or sub-carrier—this can be absolute or relative to the response). In a further example, the response of the BI signal transmitted from the UE-B to the UE-A includes a reference (e.g., index) to the BI signal from the UE-A.

In one example, a BI signal is an S-SSB. In one example, an S-SSB can include and/or indicate a UE-ID. In one example, an S-SSB can include and/or indicate a beam ID.

In one example, a first UE (e.g., UE-B or UE-A) receives or attempts to receive the BI signal transmitted on multiple second UE (e.g., UE-A or UE-B) transmit beams (e.g., second UE (e.g., UE-A or UE-B) spatial domain transmission filter).

The first UE can determine a preferred or best beam for a transmission from the second UE according to one or more of the following examples.

In one example, if a BI signal is successfully decoded, first UE determines a preferred or best beam for a transmission from the second UE to the first UE based on the decoded BI signal from the second UE.

In one example, if a beam indication signal is successfully decoded and SL RSRP of the BI signal exceeds a SL RSRP threshold or SL SINR of the BI signal exceeds a SL SINR threshold, first UE determines a preferred or best beam for a transmission from the second UE to the first UE based on the decoded BI signal from the second UE. The SL RSRP or SL SINR can be determined based on the PSCCH DMRS or based on the PSSCH DMRS. The SL RSRP threshold or SL SINR threshold can be pre-configured, and/or configured or updated by RRC signaling from a network and/or RRC signaling over PC5 and/or MAC CE signaling and L1 control signaling. In one example, if a SL RSRP threshold or SL SINR threshold is not (pre-)configured, a default value specified in the system specification is used. In one example, the SL RSRP threshold or SL SINR threshold depends on the priority of the corresponding DCR (or link establishment message) message.

In one example, if multiple BI signals are successfully decoded, the first UE determines the BI signal with the largest SL RSRP or SL SINR. The SL RSRP or SL SINR can be determined based on the PSCCH DMRS or based on the PSSCH DMRS. The first UE determines a preferred or best beam for a transmission from the second UE to the first UE based on the decoded BI signal from the second UE with the largest SL RSRP or SL SINR. In one further example, a window can be (pre-)configured during which the UE-B attempts to receive BI signal. In one example, the window starts in the slot or time occasion of the first successfully decoded BI signal (or in the following slot or time occasion) and ends T slots or time occasions later. Where, in one example, T can be in units of logical slots in a resource pool. In another example, T can be in units of physical slots. In another example, T can be in units of time occasions. In another example, T can be in units of symbols. In one example, T can be pre-configured, and/or configured or updated by RRC signaling from a network and/or RRC signaling over PC5 and/or MAC CE signaling and L1 control signaling. In one example, T can be specified in the system specifications. In one example, if T is not (pre-)configured, a default value specified in the system specification is used.

In one example, if multiple BI signals are successfully decoded with SL RSRP or SL SINR of the BI signal exceeding a SL RSRP threshold or a SL SINR threshold, the first UE determines the BI signal with the largest SL RSRP or SL SINR. The first UE determines a preferred or best beam for a transmission from the second UE to the first UE based on the determined decoded BI signal from the second UE with the largest SL RSRP or SL SINR. The SL RSRP or SL SINR can be determined based on the PSCCH DMRS or based on the PSSCH DMRS. The SL RSRP threshold or SL SINR threshold can be pre-configured, and/or configured or updated by RRC signaling from a network and/or RRC signaling over PC5 and/or MAC CE signaling and L1 control signaling. In one example, if a SL RSRP threshold or SL SINR threshold is not (pre-)configured, a default value specified in the system specification is used. In one example, the SL RSRP threshold or SL SINR threshold depends on the priority of the corresponding BI signal. In one further example, a window can be (pre-)configured during which the first UE attempts to receive BI signal.

In one example, the window starts in the slot or time occasion of the first successfully decoded BI signal (or in the following slot or time occasion) and ends T slots or time occasions later. In one example, T can be in units of logical slots in a resource pool. In another example, T can be in units of physical slots. In another example, T can be in units of time occasions. In another example, T can be in units of symbols. In one example, T can be pre-configured, and/or configured or updated by RRC signaling from a network and/or RRC signaling over PC5 and/or MAC CE signaling and L1 control signaling. In one example, T can be specified in the system specifications. In one example, if T is not (pre-)configured, a default value specified in the system specification is used.

In one example, the first UE receives or attempts to receive BI signal corresponding to all transmitted beams from the second UE before determining the BI signal with preferred or best beam for a transmission from the second UE to the first UE. For example, within a (pre-)configured window as previously described.

In one example, once first UE successfully decodes a BI signal, the first UE determines a preferred or best beam for a transmission from the second UE to the first UE corresponding to the BI signal that is successfully decoded. In a variant of this example, it can be up to the implementation of the first UE whether to wait for decoding other BI signals or not before the first UE determines a preferred or best beam for a transmission from the second UE to the first UE (for example within a (pre-)configured window as previously described).

In one example, once first UE successfully decodes a BI message and the corresponding SL RSRP or SL SINR of the BI exceeds a SL RSRP threshold or SL SINR threshold, the first UE determines a preferred or best beam for a transmission from the second UE to the first UE corresponding to the BI signal that is successfully decoded and that exceeds a SL RSRP threshold or SL SINR threshold. The SL RSRP or SL SINR can be determined based on the PSCCH DMRS or based on the PSSCH DMRS. The SL RSRP threshold or SL SINR threshold can be pre-configured, and/or configured or updated by RRC signaling from a network and/or RRC signaling over PC5 and/or MAC CE signaling and L1 control signaling. In one example, if a SL RSRP threshold or SL SINR threshold is not (pre-)configured, a default value specified in the system specification is used. In one example, the SL RSRP threshold or SL SINR threshold depends on the priority of the corresponding BI signal or DCR message. In a variant of this example, it can be up to the implementation of the first UE whether to wait for decoding other BI signals or not before the first UE determines a preferred or best beam for a transmission from the second UE to the first UE. In one example if the first UE waits, the decoded BI signals can be within a (pre-)configured window as previously described.

In one example, if no BI signal with a SL RSRP that exceeds a SL RSRP threshold at the first UE or SL SINR that exceeds a SL SINR threshold, the first UE receives or attempts to receive BI signal corresponding to all transmitted beams from second UE before the first UE determines a preferred or best beam for a transmission from the second UE to the first UE. In one example, the decoded BI signals can be within a (pre-)configured window as previously described. The first UE determines the BI signal with the largest SL RSRP or SL SINR. The SL RSRP or SL SINR can be determined based on the PSCCH DMRS or based on the PSSCH DMRS. The SL RSRP threshold or SL SINR threshold can be pre-configured, and/or configured or updated by RRC signaling from a network and/or RRC signaling over PC5 and/or MAC CE signaling and L1 control signaling. In one example, if a SL RSRP threshold or SL SINR threshold is not (pre-)configured, a default value specified in the system specification is used. In one example, the SL RSRP threshold or SL SINR threshold depends on the priority of the corresponding BI signal or DCR message.

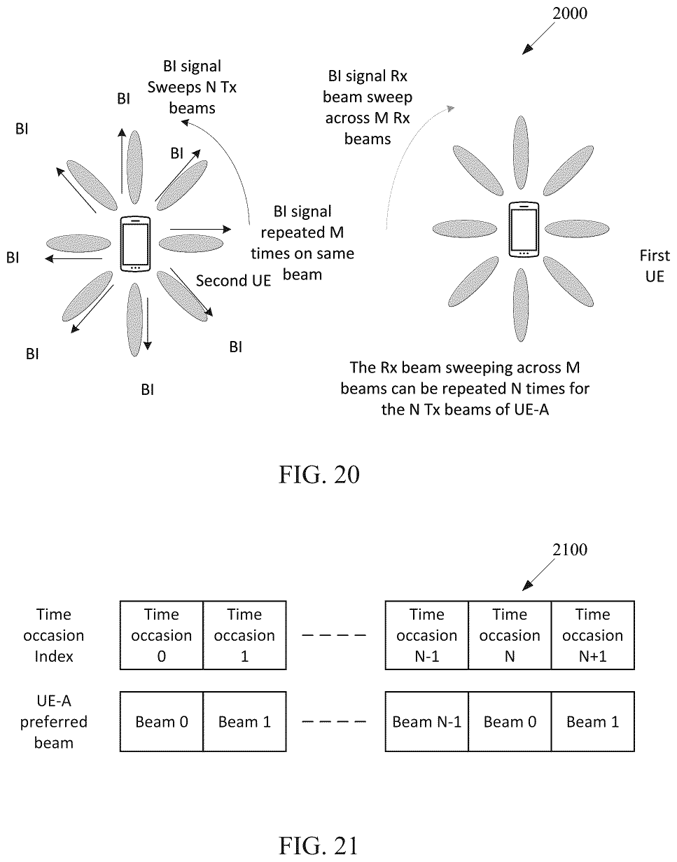

In one example, the second UE repeats the BI signal on the same transmit beam (spatial domain transmission filter) the first UE attempts to receive the repeated BI signal using different receive beams (spatial domain reception filters) to find the best receiver beam (spatial domain reception filter) to use (at the first UE). In one example, the resource pool can be (pre-)configured whether repetition is on or off. Repetition can be pre-configured, and/or configured or updated by RRC signaling from a network and/or RRC signaling over PC5 and/or MAC CE signaling and L1 control signaling. In one example, if repetition is not (pre-)configured, a default value specified in the system specification is used. When repetition is on, the first UE can assume that the BI signal is repeated using the same transmit beam (spatial domain transmission filter) from second UE. When repetition is off, the first UE cannot assume that the BI signal is repeated using the same transmit beam (spatial domain transmission filter) from the second UE. When repetition is on, the resource pool can be (pre-)configured with the number of repetitions M, where M is the number of BI signal instances on the same transmit beam (spatial domain transmission filter) from the second UE. M can be pre-configured, and/or configured or updated by RRC signaling from a network and/or RRC signaling over PC5 and/or MAC CE signaling and L1 control signaling. In one example, if M is not (pre-)configured, a default value specified in the system specification is used. An example of transmit and receive beam sweeping is illustrated in FIG. 20.

FIG. 20 illustrates yet another example of beam indication 2000 according to embodiments of the present disclosure. An embodiment of the beam indication 2000 shown in FIG. 20 is for illustration only.

In one example, the first UE receives or decodes the BI signal and determines a preferred or best beam for a transmission from the second UE to the first UE based on a slot or time occasion or resource index of a BI signal as mentioned in example in the present disclosure. In one example, the slot index can be a logical slot index. In one example, the slot index can be a physical slot index.

In one example, the first UE receives or decodes the BI signal and determines a preferred or best beam for a transmission from the second UE to the first UE based on a S-SSB index as mentioned in example of the present disclosure.

In one example, the first UE receives or decodes the BI signal and determines a preferred or best beam for a transmission from the second UE to the first UE based on a parameter (value) (e.g., beam index) included in the BI signal as mentioned in example of the present disclosure.

In one example, the first UE receives or decodes the BI signal and determines a preferred or best beam for a transmission from the second UE to the first UE based on a CSI-RS as mentioned in example of the present disclosure.

In one example, the first UE receives or decodes the BI signal. The response to, or action based on, the BI signal (e.g., when used for a direct communication request) can include information about the resource or some other characteristic of the BI signal, which can implicitly indicate a preferred or best beam for a transmission from the second UE to the first UE as mentioned in example of the present disclosure.

In one example, the beam indication signal can include one or more of the following information: (1) an index or identity or source ID or destination ID or part of source ID (e.g., N MSB of source ID, or N LSB of source ID—for example N can of 8 or 16) or part of destination ID (e.g., N MSB of destination ID, or N LSB of destination ID—for example N can be 8 or 16) of the UE transmitting the beam indication signal; (2) an index or identity of a beam corresponding to the beam indication signal; (3) a list of one or more slots or time occasions or resources during which the UE that transmitted the beam indication signal may receive in a direction of (or associated with) the beam corresponding to the beam indication signal; and (4) information about preferred or best transmit beam (e.g., transmit spatial domain filter) index or ID of second UEs when the second UEs are transmitting to the UE transmitting the beam indication signal.

In one example, a BI signal includes identity of UEs associated with beam direction.

In a further example, and a BI signal further includes corresponding beam identities for transmissions from these UEs.

In one example, a BI signal includes information related to the slots and/or symbols and/or resources and/or time occasions in which the UE can receive in a direction corresponding to the transmit direction of the BI signal.

In one example, the slots and/or symbols and/or resources and/or time occasions in which UE can receive is determined implicitly e.g., based an association between transmit slot and/or symbol and/or resource and/or time occasion and the corresponding receive slots and/or symbols and/or resources and/or time occasions. This association can be configured and/or specified.

In one example, the slots and/or symbols and/or resources and/or time occasions in which UE can receive is determined implicitly e.g., based an association between transmit beam (or spatial domain transmit filter) ID and the corresponding receive slots and/or symbols and/or resources and/or time occasions. This association can be configured and/or specified.

In one example, the slots and/or symbols and/or resources and/or time occasions in which UE can receive is determined based on a receive beam signaled and/or indicated in the BI signal. There is an association between the receive beam (or spatial domain receive filter) ID and the corresponding receive slots and/or symbols and/or resources and/or time occasions. This association can be configured and/or specified.

In one example, the slots and/or symbols and/or resources and/or time occasions in which UE transmitting the BI (or BI response) can receive are signaled and/or indicated in the BI signal (or BI response signal).

A first UE (e.g., UE-B) transmits a direct communication request (DCR) or BI response that includes the Target User Info for a second UE (e.g., UE-A). The first UE transmits the DCR or BI response on a best or preferred transmit beam (e.g., spatial domain transmission filter) for transmission from first UE to the second UE.

In one example, the DCR or BI response includes or indicates a best or preferred transmit beam (e.g., spatial domain transmission filter) for transmission from the second UE to the first UE based on the reception by the first UE of a BI signal transmitted from the second UE.

FIGS. 21-23 illustrate yet another examples of time occasions or resource index determinations 2100-2300 according to embodiments of the present disclosure. An embodiment of the time occasions or resource slot index determinations 2100-2300 shown in FIGS. 21-23 are for illustration only.

In one example, the DCR or BI response is transmitted in a slot or time occasions or resource, wherein the slot or time occasions or resource index is determined or is linked to a preferred or best beam for the second UE, e.g., preferred or best UE-A transmit (or receive) beam (or e.g., preferred or best UE-A spatial domain transmission (or reception) filter). In one example, the slot or time occasions or resource index is a physical slot index. In one example, the slot index is a logical slot index within the resource pool.

In one example, illustrated in FIG. 21, if there are N UE-A transmit (or receive) beams (e.g., UE-A spatial domain transmission (or reception) filters), 0, 1, . . . , N−1, a DCR or BI response transmitted in a slot or time occasions or resource with index m, if the preferred or best UE-A transmit (or receive) beam (e.g., spatial domain transmission (or reception) filter) n, such that m % N=n. Where % is the modulo operator that determines the remainder after dividing m by N. In one example, if an initial transmission of the DCR message or BI response is in slot or time occasions or resource m₀, a retransmission of the DCR message or BI response is in slot or time occasions or resource m₁ such that m₀% N=m₁% N. In a variant example, if an initial transmission of the DCR message or BI response is in slot or time occasion or resource m₀ a retransmission of the DCR message or BI response is in slot or time occasion or resource m₁ can be such that m₀% N≠m₁% N, i.e., a different beam is used for re-transmission.

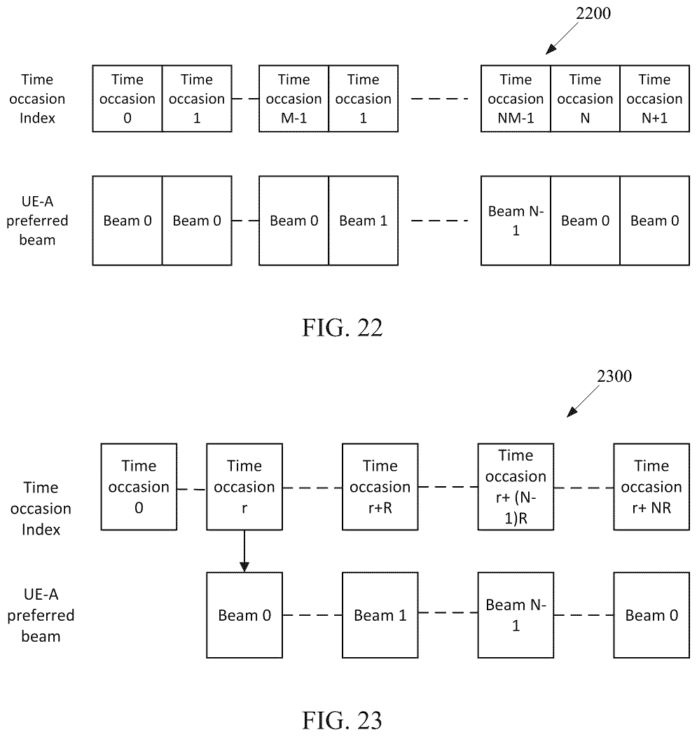

In one example, illustrated in FIG. 22, if there are N UE-A transmit (or receive) beams (e.g., UE-A spatial domain transmission (or reception) filters), 0, 1, . . . , N−1, a DCR transmitted in a slot or time occasions or resource with index m, has a preferred transmit (or receive) beam (e.g., spatial domain transmission (or reception) filter) n of the second UE (e.g., UE-A), such that

$$⌊ \frac{m}{M} ⌋ \% N = n .$$

Where % is the modulo operator that determines the remainder after dividing [symbol] by N. Where, M is the number of slot a DCR message or BI response can be repeated on the same beam. M can be pre-configured, and/or configured or updated by RRC signaling from a network and/or RRC signaling over PC5 and/or MAC CE signaling and L1 control signaling. In one example, M can be specified in the system specifications. In one example, if M is not (pre-)configured, a default value specified in the system specification is used. In one example, if an initial transmission of the DCR message or BI response is in slot or time occasions or resource m₀ a retransmission of the DCR message or BI response is in slot or time occasions or resource m₁ such that m₀% NM=m₁% NM. In a variant example, if an initial transmission of the DCR message or BI response is in slot or time occasion or resource m₀, a retransmission of the DCR message or BI response is in slot or time occasion or resource m₁ can be such that m₀% NM≠m₁% NM, i.e., a different beam is used for re-transmission.

In one example, illustrated in FIG. 23, if there are N UE-A transmit (or receive) beams (e.g., UE-A spatial domain transmission (or reception) filters), 0, 1, . . . , N−1, a DCR or BI response transmitted in a slot or time occasions or resource with index m, has a preferred or best transmit (or receive) beam (e.g., spatial domain transmission filter) n of the second UE (e.g., UE-A), such that

$$( m - r ) \% R = 0 and ( \frac{m - r}{R} ) \% N = n .$$

Where % is the modulo operator that determines the remainder after dividing

$$( \frac{m - r}{R} )$$

by N. R can be pre-configured, and/or configured or updated by RRC signaling from a network and/or RRC signaling over PC5 and/or MAC CE signaling and L1 control signaling. In one example, R can be specified in the system specifications. In one example, if R is not (pre-)configured, a default value specified in the system specification is used. r can be pre-configured, and/or configured or updated by RRC signaling from a network and/or RRC signaling over PC5 and/or MAC CE signaling and L1 control signaling. In one example, r can be specified in the system specifications, e.g., r=0. In one example, if r is not (pre-)configured, a default value specified in the system specification is used, e.g., r=0. In one example, if an initial transmission of the DCR message or BI response is in slot or time occasions or resource m₀, a retransmission of the DCR message or BI response is in slot or time occasions or resource m₁ such that m₀% NR=m₁% NR. In a variant example, if an initial transmission of the DCR message or BI response is in slot or time occasion or resource m₀, a retransmission of the DCR message or BI response is in slot or time occasion or resource m₁ can be such that m₀% NR≠m₁% NR i.e., a different beam is used for re-transmission.

In one example, a most recent S-SSB transmission (from UE-A or from UE-B) determines or is linked to a second UE (e.g., UE-A) preferred or best transmit (or receive) beam (e.g., UE-A spatial domain transmission (or reception) filter). A SL UE receives or transmits the following SL synchronization signals and broadcast channel: (1) SL primary synchronization signal (S-PSS), (2) SL secondary synchronization signal (S-SSS), and (3) physical SL broadcast channel (PSBCH). The UE assumes that reception occasions of a PSBCH, S-PSS and S-SSS are in consecutive symbols and forms a S-SS/PSBCH block (S-SSB). The UE is provided, by higher layer parameter sl-NumSSB-WithinPeriod, a number of N_{period}^{S-SSB} S-SSBs in a period of 16 frames.

Where the allowed values for sl-NumSSB-WithinPeriod (N_{period}^{S-SSB}), depends on the frequency range and the sub-carrier spacing (SCS): (1) for FR1 and SCS=15 kHz, N_{period}^{S-SSB}∈{1}; (2) for FR1 and SCS=30 kHz, N_{period}^{S-SSB}∈{1,2}; (3) for FR1 and SCS=60 kHz, N_{period}^{S-SSB}∈{1, 2,4}; (4) for FR2 and SCS=60 kHz, N_{period}^{S-SSB}∈{1, 2,4,8,16, 32}; and (5) for FR2 and SCS=120 kHz, N_{period}^{S-SSB}∈{1, 2, 4, 6,16, 32, 64}.

The transmission of the S-SSBs of the period is with a periodicity of 16 frames. The index of slots used for the transmission of SSBs with index i_{S-SSB}∈{0, 1, . . . , N_{period}^{S-SSB}−1} are determined by: N_{offset}^{S-SSB}+(Nᵢₙₜₑᵣᵥₐₗ^{S-SSB}+1)·i_{S-SSB} where: (1) slot index 0, corresponds to the first slots of frame with (SFN mod 16)=0, or (DFN mod 16)=0; (2) N_{offset}^{S-SSB} is given by higher layer parameter sl-TimeOffsetSSB, which is in the range {0,1, . . . , 1279}; and (3)Nᵢₙₜₑᵣᵥₐₗ^{S-SSB} is given by higher layer parameter which is in the range {0,1, . . . , 639}. In the following a first Tx beam can used for S-SSB0, a second Tx beam can be used for S-SSB1, etc.

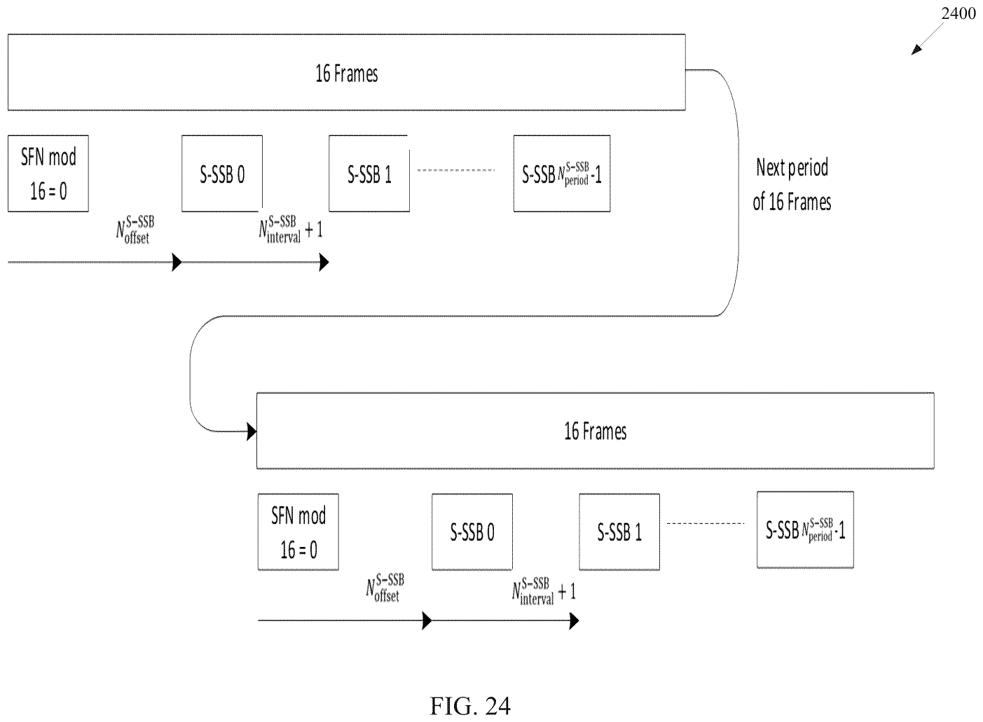

FIG. 24 illustrates yet another example of S-SSBs 2400 according to embodiments of the present disclosure. An embodiment of the S-SSBs 2400 shown in FIG. 24 is for illustration only.

In one example, a direct communication request transmission or BI response between S-SSB 0 and S-SSB 1 is associated with or linked to a first transmit (or receive) beam (e.g., spatial domain transmission (or reception) filter) of the second UE (e.g., UE-A), a direct communication request transmission or BI response between S-SSB 1 and S-SSB 2 is associated with or linked to a second transmit (or receive) beam (e.g., a spatial domain transmission (or reception) filter) of the second UE (e.g., UE-A), . . . , a direct communication request transmission or BI response between -SSB N_{period}^{S-SSB}−2 and S-SSB N_{period}^{S-SSB}−1 is associated with or linked to a (N_{period}^{S-SSB}−1) transmit (or receive) beam (e.g., a spatial domain transmission (or reception) filter) of the second UE (e.g., UE-A), direct communication request transmission or BI response after S-SSB N_{period}^{S-SSB}−1 and before S-SSB 0 of the next 16-frame period is associated with or linked to a N_{period}^{S-SSB} r transmit (or receive) beam (e.g., a spatial domain transmission (or reception) filter) of the second UE (e.g., UE-A). In a variant, the association is based on the slots before S-SSB.

In one example, a direct communication request transmission or BI response between S-SSB 0 and S-SSB 1 is associated with or linked to a first transmit (or receive) beam (e.g., a spatial domain transmission (or reception) filter) of the second UE (e.g., UE-A), a direct communication request transmission or BI response between S-SSB 1 and S-SSB 2 is associated with or linked to a second transmit (or receive) beam (e.g., a spatial domain transmission (or reception) filter) of the second UE (e.g., UE-A), . . . , a direct communication request transmission or BI response between S-SSB N_{period}^{S-SSB}−2 and S-SSB N_{period}^{S-SSB}−1 is associated with or linked to a (N_{period}^{S-SSB}−1) transmit (or receive) beam (e.g., a spatial domain transmission (or reception) filter) of the second UE (e.g., UE-A), a direct communication request transmission or BI response after S-SSB N_{period}^{S-SSB}−1 and before the period end of the 16-frame period is associated with or linked to a N_{period}^{S-SSB} transmit (or receive) beam (e.g., a spatial domain transmission (or reception) filter) of the second UE (e.g., UE-A). In a variant, the association is based on the slots before S-SSB.

In one example, a direct communication request transmission or BI response between S-SSB 0 and S-SSB 1 is associated with or linked to a first transmit (or receive) beam (e.g., a spatial domain transmission (or reception) filter) of the second UE (e.g., UE-A), a direct communication request transmission or BI response between S-SSB 1 and S-SSB 2 is associated with or linked to a second transmit (or receive) beam (e.g., a spatial domain transmission (or reception) filter) of the second UE (e.g., UE-A), . . . , a direct communication request transmission or BI response between S-SSB N_{period}^{S-SSB}−2 and S-SSB N_{period}^{S-SSB}−1 is associated with or linked to a (N_{period}^{S-SSB}−1) transmit (or receive) beam (e.g., a spatial domain transmission (or reception) filter) of the second UE (e.g., UE-A), a direct communication request transmission or BI response after S-SSB N_{period}^{S-SSB}−1 and for Nᵢₙₜₑᵣᵥₐₗ^{S-SSB} slots from S-SSB N_{period}^{S-SSB}−1 is associated with or linked to a N_{period}^{S-SSB} transmit (or receive) beam (e.g., a spatial domain transmission (or reception) filter) of the second UE (e.g., UE-A). In a variant, the association is based on the slots before S-SSB.

In one example, a direct communication request transmission or BI response after S-SSB 0 and before S-SSB 1 and for no more than K slots starting from S-SSB 0 is associated with or linked to a first transmit (or receive) beam (e.g., a spatial domain transmission (or reception) filter) of the second UE (e.g., UE-A), a direct communication request transmission or BI response after S-SSB 1 and before S-SSB 2 and for no more than K slots starting from S-SSB 1 is associated with or linked to a second transmit (or receive) beam (e.g., a spatial domain transmission (or reception) filter) of the second UE (e.g., UE-A), . . . , a direct communication request transmission or BI response after S-SSB N_{period}^{S-SSB}−2 and before S-SSB N_{period}^{S-SSB}−1 and for no more than K slots starting from S-SSB N_{period}^{S-SSB}−2 is associated with or linked to a (N_{period}^{S-SSB}−1) transmit (or receive) beam (e.g., a spatial domain transmission (or reception) filter) of the second UE (e.g., UE-A), a direct communication request transmission or BI response after S-SSB N_{period}^{S-SSB}−1 and before S-SSB 0 of next 16-frame interval and for no more than K slots starting from S-SSB N_{period}^{S-SSB}−1 is associated with or linked to a N_{period}^{S-SSB} transmit (or receive) beam (e.g., a spatial domain transmission (or reception) filter) of the second UE (e.g., UE-A).

In one example, K is in units of logical slots in a resource pool. In one example, K is in units of physical slots. In one example, K is in symbols. In one example, K is in time occasions. K can be pre-configured, and/or configured or updated by RRC signaling from a network and/or RRC signaling over PC5 and/or MAC CE signaling and L1 control signaling. In one example, K can be specified in the system specifications, for example K=1 or K=2. In one example, if K is not (pre-)configured, a default value specified in the system specification is used for example K=1 or K=2. In one example, K is the same for all S-SSBs. In one example, a different K can be configured for each S-SSB or for some of the S-SSBs. In a variant, the association is based on the slots before S-SSB.

In one example, a direct communication request transmission or BI response after S-SSB 0 and before S-SSB 1 and for no more than K slots starting from S-SSB 0 is associated with or linked to a first transmit (or receive) beam (e.g., a spatial domain transmission (or reception) filter) of the second UE (e.g., UE-A), a direct communication request transmission or BI response after S-SSB 1 and before S-SSB 2 and for no more than K slots starting from S-SSB 1 is associated with or linked to a second transmit (or receive) beam (e.g., a spatial domain transmission (or reception) filter) of the second UE (e.g., UE-A), . . . , a direct communication request transmission or BI response after S-SSB N_{period}^{S-SSB}−2 and before S-SSB N_{period}^{S-SSB}−1 and for no more than K slots starting from S-SSB N_{period}^{S-SSB}−2 is associated with or linked to a (N_{period}^{S-SSB}−1) transmit (or receive) beam (e.g., a spatial domain transmission (or reception) filter) of the second UE (e.g., UE-A), a direct communication request transmission or BI response after S-SSB N_{period}^{S-SSB}−1 and before the end of the 16-frame interval and for no more than K slots starting from S-SSB N_{period}^{S-SSB}−1 is associated with or linked to a N_{period}^{S-SSB} UE-A transmit (or receive) (e.g., a spatial domain transmission (or reception) filter) of the second UE (e.g., UE-A). In one example, K is in units of logical slots in a resource pool.

In one example, K is in units of physical slots. In one example, K is in symbols. In one example, K is in time occasions. K can be pre-configured, and/or configured or updated by RRC signaling from a network and/or RRC signaling over PC5 and/or MAC CE signaling and L1 control signaling. In one example, K can be specified in the system specifications, for example K=1 or K=2. In one example, if K is not (pre-)configured, a default value specified in the system specification is used for example K=1 or K=2. In one example, K is the same for all S-SSBs. In one example, a different K can be configured for each S-SSB or for some of the S-SSBs. In a variant, the association is based on the slots before S-SSB.

In one example, a direct communication request transmission or BI response after S-SSB 0 and for no more than K slots starting from S-SSB 0 is associated with or linked to a first transmit (or receive) beam (e.g., a spatial domain transmission (or reception) filter) of the second UE (e.g., UE-A), a direct communication request transmission or BI response after S-SSB 1 and for no more than K slots starting from S-SSB 1 is associated with or linked to a second transmit (or receive) beam (e.g., a spatial domain transmission (or reception) filter) of the second UE (e.g., UE-A), . . . , a direct communication request transmission or BI response after S-SSB N_{period}^{S-SSB}−2 and for no more than K slots starting from S-SSB N_{period}^{S-SSB}−2 is associated with or linked to a (N_{period}^{S-SSB}−1) transmit (or receive) beam (e.g., a spatial domain transmission (or reception) filter) of the second UE (e.g., UE-A), a direct communication request transmission or BI response after S-SSB N_{period}^{S-SSB}−1 and for no more than K slots starting from S-SSB N_{period}^{S-SSB}−1 is associated with or linked to a N_{period}^{S-SSB} transmit (or receive) beam (e.g., a spatial domain transmission (or reception) filter) of the second UE (e.g., UE-A).

In one example, K is in units of logical slots in a resource pool. In one example, K is in units of physical slots. In one example, K is in symbols. In one example, K is in time occasions. K can be pre-configured, and/or configured or updated by RRC signaling from a network and/or RRC signaling over PC5 and/or MAC CE signaling and L1 control signaling. In one example, K can be specified in the system specifications, for example K=1 or K=2. In one example, if K is not (pre-)configured, a default value specified in the system specification is used for example K=1 or K=2. In one example, K is the same for all S-SSBs. In one example, a different K can be configured for each S-SSB or for some of the S-SSBs. In a variant, the association is based on the slots before S-SSB.

In one example, a parameter (value) is included in the direct communication request (DCR) or BI response, wherein the parameter (value) determines or is linked to a second UE (e.g., UE-A) transmit beam (e.g., a second UE (e.g., UE-A) spatial domain transmission filter). In one example, the parameter (value) can be a second UE (e.g., UE-A) transmit beam (e.g., a second UE (e.g., UE-A) spatial domain transmission filter) index.

In one example, the parameter (value) is a field in a first stage SCI in a PSCCH channel associated with the DCR or BI response.

In one example, the parameter (value) is a field in a second stage SCI in a PSSCH channel associated with the DCR or BI response.

In one example, the parameter (value) is a field in a SL shared channel (SL-SCH) in a PSCCH channel associated with the DCR or BI response.

In one example, the parameter (value) is a field in MAC CE associated with the DCR or BI response.

In one example, a direct communication request or BI response includes a CSI-RS.

In one example, the sequence of the CSI-RS resource is generated according to:

$$r ( m ) = \frac{1}{\sqrt{2}} ( 1 - 2 c ( 2 m ) ) + j \frac{1}{\sqrt{2}} ( 1 - 2 c ( 2 m + 1 ) ) where , m = 0 , 1 , … .$$

The pseudo-random sequence c(n) is a length-31 Gold sequence defined as c(n)=(x₁(n+N_{c})+x₂(n+N_{c})) mod 2 where: (1) N_{c}=1600; (2) x₁(n+31)=(x₁(n+3)+x₁(n)) mod 2; and (3) x₁(n+31)=(x₂(n+3)+x₂(n+2)+x₂(n+1)+x₂(n)) mod 2.

The first m-sequence is initialized with x₁(0)=1, and x₂(n)=0, for n=1 . . . 30. The second m-sequence is initialized with cᵢₙᵢₜ, where cᵢₙᵢₜ:Cᵢₙᵢₜ=(2¹⁰(N_{symb}^{slot}n_{s,f}^{μ}+l+1) (2n_{ID}+1)+n_{ID}) mod 2³¹ where: (1) N_{symb}^{slot} is the number of symbols in a slot; (2) n_{s,f}^{μ} is the number of slots in a frame for sub-carrier spacing configuration μ; (3) l is the OFDM symbol number in a slot; and (4) n_{ID}=N_{ID}^{x} mod 2¹⁰, where N_{ID}^{x} is the decimal representation of CRC of the first stage SL control information carried on PSCCH.

In one example, the sequence of the CSI-RS resource is same for all second UE (e.g., UE-A) transmit beams (e.g., second UE (e.g., UE-A) spatial domain transmission filters).

In one example, the sequence of the CSI-RS resource depends on (is a function of) the second UE (e.g., UE-A) transmit beam index (e.g., second UE (e.g., UE-A) spatial domain transmission filter index). In one example, the sequence n_{ID} depends on the second UE (e.g., UE-A) transmit beam index (e.g., second UE (e.g., UE-A) spatial domain transmission filter index). In one example, the equation for cᵢₙᵢₜ depends on the second UE (e.g., UE-A) transmit beam index (e.g., the second UE (e.g., UE-A) spatial domain transmission filter index).

In one example, the resource of the beam indication (signal) corresponding to a preferred or best beam for transmission from the second UE (e.g., UE-A) to the first UE (e.g., UE-B) is included or indicated in the DCR or BI response from the first UE to the second UE. Based on this, the second UE (e.g., UE-A) can determine the preferred or best beam for transmission from the second UE (e.g., UE-A) to the first UE (e.g., UE-B).

In one example, the DCR or BI response is transmitted in a slot or time occasion or resource, wherein the slot or time occasion or resource is associated with a receive beam used by the second UE (e.g., UE-A) to receive in the slot.

In one example, the slot or time occasion or resource index is determined or is linked to a preferred or best beam for the second UE, e.g., preferred or best UE-A receive beam (or e.g., preferred or best UE-A spatial domain reception filter) as mentioned in example of the present disclosure.

In one example, the slot or time occasion or resource is determined based on an S-SSB transmission, wherein the S-SSB transmission (determines or is linked to a second UE (e.g., UE-A) preferred or best receive beam (e.g., UE-A spatial domain reception filter) as mentioned in example of the present disclosure.

In one example, the preferred beam indication signal includes a list of slots for the corresponding beam indication. The first UE (e.g., UE-B) transmits the DCR or BI response in one of the indicated slots or time occasions or resources. The second UE (e.g., UE-A) receives in a direction corresponding to the preferred beam indication in the list of slots or time occasions or resources.

The present disclosure includes: (1) a beam indication signal to identify preferred beams for communication between UEs and (2) transmission and reception of direct communication request or beam indication response based on beams identified by beam indication signal.

The present disclosure provides design components for the SL beam management. This beneficial for the operation of SL in FR2. The benefit of operating in FR2 is to have access to large BW for applications demanding very high data rates and throughputs.

Sidelink is one of the promising features of NR, targeting verticals such the automotive industry, public safety and other commercial application. Sidelink has been first introduced to NR in release 16 and further enhanced in release 17. In release 18, one of the objectives of SL is to study beam management to support operation in FR2. The present disclosure provides an initial beam acquisition design for SL.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to:
transmit, to a second UE, first channels using multiple spatial domain transmit filters, respectively, and
receive, from the second UE, a second channel indicating first assistance information associated with a spatial domain transmit filter; and
a processor operably coupled to the transceiver, the processor configured to determine the spatial domain transmit filter based on the first assistance information,
wherein the transceiver is further configured to transmit, based on the spatial domain transmit filter, a third channel that includes a first link establishment message.

2. The UE of claim 1, wherein the first channels include a sidelink channel state information-reference signal (SL CSI-RS).

3. The UE of claim 1, wherein a channel from the first channels is associated with a sidelink (SL) synchronization signals and physical sidelink broadcast channel (SS/PSBCH) block.

4. The UE of claim 1, wherein a channel from the first channels is repeatedly transmitted using a same spatial domain transmit filter from the multiple spatial domain transmit filters.

5. The UE of claim 1, wherein the second channel includes a second link establishment message.

6. The UE of claim 1, wherein:
an ith set of time occasions is associated with an ith spatial domain transmit filter, and
i=1, . . . N, where N is a number of spatial domain transmit filters.

7. The UE of claim 1, wherein:
a first channel from the first channels is transmitted in a first time occasion,
the processor is further configured to determine a second time occasion associated with the first time occasion, and
the second channel is received in the second time occasion.

8. The UE of claim 1, wherein:
the transceiver is further configured to receive, from a third UE, third channels for beam identification;
the processor is further configured to:
determine metrics associated with the third channels, and
determine a spatial domain receive filter to receive signals from the third UE; and the transceiver is further configured to:
transmit, to the third UE, a fourth channel including second assistance information, the second assistance information based on the metrics, and
receive subsequent signals from the third UE using the spatial domain receive filter.

9. The UE of claim 8, wherein the fourth channel includes a second link establishment message to the third UE.

10. The UE of claim 8, wherein:
a third channel from the third channels is received in a first time occasion,
the processor is further configured to determine a second time occasion associated with the first time occasion, and
the second time occasion is used to transmit the fourth channel.

11. A method of operating a user equipment (UE), the method comprising:
transmitting, to a second UE, first channels using multiple spatial domain transmit filters, respectively;
receiving, from the second UE, a second channel indicating first assistance information associated with a spatial domain transmit filter;
determining the spatial domain transmit filter based on the first assistance information; and
transmitting, based on the spatial domain transmit filter, a third channel that includes a first link establishment message.

12. The method of claim 11, wherein the first channels include a sidelink channel state information-reference signal (SL CSI-RS).

13. The method of claim 11, wherein a channel from the first channels is associated with a sidelink (SL) synchronization signals and physical sidelink broadcast channel (SS/PSBCH) block.

14. The method of claim 11, wherein a channel from the first channels is repeatedly transmitted using a same spatial domain transmit filter from the multiple spatial domain transmit filters.

15. The method of claim 11, wherein the second channel includes a second link establishment message.

16. The method of claim 11, wherein:
an ith set of time occasions is associated with an ith spatial domain transmit filter, and
i=1, . . . N, where N is a number of spatial domain transmit filters.

17. The method of claim 11, wherein:
transmitting the first channels further comprises transmitting a first channel, from the first channels, in a first time occasion,
the method further comprises determining a second time occasion associated with the first time occasion, and
receiving the second channel further comprises receiving the second channel in the second time occasion.

18. The method of claim 11, further comprising:
receiving, from a third UE, third channels for beam identification;
determining metrics associated with the third channels;
determining a spatial domain receive filter to receive signals from the third UE;
transmitting, to the third UE, a fourth channel including second assistance information, the second assistance information based on the metrics; and
receiving subsequent signals from the third UE using the spatial domain receive filter.

19. The method of claim 18, wherein the fourth channel includes a second link establishment message to the third UE.

20. The method of claim 18, wherein:
transmitting the third channels further comprises receiving a third channel, from the third channels, in a first time occasion,
the method further comprises determining a second time occasion associated with the first time occasion, and
transmitting the fourth channel further comprises transmitting the fourth channel in the second time occasion.
